(19) United States
(12) Patent Application Publication
(10) Pub. No.: US 2011/0020776 A1
(43) Pub. Date: Jan. 27, 2011

(54) LOCATING EQUIPMENT FOR AND METHODS OF SIMULATING LOCATE OPERATIONS FOR TRAINING AND/OR SKILLS EVALUATION

(75) Inventors: Steven Nielsen, North Palm Beach, FL (US); Curtis Chambers, Palm Beach Gardens, FL (US); Jeffrey Farr, Jupiter, FL (US); Thomas William Bachelder, Apex, NC (US)

Correspondence Address: WOLF GREENFIELD & SACKS, P.C., 600 ATLANTIC AVENUE, BOSTON, MA, 02210-2206, US

(73) Assignee: CertusView Technologies, LLC, Palm Beach Gardens, FL (US)

(21) Appl. No.: 12/823,498

(22) Filed: Jun. 25, 2010

Related U.S. Application Data
(60) Provisional application No. 61/220,255, filed on Jun. 25, 2009.

(51) Int. Cl. G09B 19/00

(52) U.S. Cl. 434/219

(57) ABSTRACT

Training systems for and methods of simulating locate operations are provided for training and/or skills evaluation. Facility locating equipment, such as on-site computers and/or locate receivers, may include modules for electronically simulating locate operations. Locating equipment including simulation modules may be used, for example, in locate technician training processes and/or for updating and/or evaluating the skills of locate technicians. In particular, a simulation module is provided for electronically generating “virtual” facilities, the presence and/or absence of which may be indicated to a locate technician during, for example, a training exercise. The actions of the locate technicians with respect to dispensing marking material that corresponds to the presence and/or absence of the virtual facilities are electronically captured, stored, and evaluated.

### CROSS REFERENCE TO RELATED APPLICATION

This application claims a priority benefit, under 35 U.S.C. §119(e), to U.S. Provisional Application Ser. No. 61/220,255, entitled “Locating Equipment for and Methods of Simulating Locate Operations for Training and/or Skills Evaluation,” filed Jun. 25, 2009 under attorney docket no. D0687.70035US00, which is hereby incorporated by reference in its entirety.

### TECHNICAL FIELD

The present invention relates generally to the field of processes for training underground facility locate technicians. In particular, the present disclosure is directed to locating equipment for, and methods of, simulating locate operations for training and/or skills evaluation.

### BACKGROUND

Field service operations may be any operation in which companies dispatch technicians and/or other staff to perform certain activities, for example, installations, services and/or repairs. Field service operations may exist in various industries, examples of which include, but are not limited to, network installations, utility installations, security systems, construction, medical equipment, heating, ventilating and air conditioning (HVAC) and the like.

An example of a field service operation in the construction industry is a so-called “locate and marking operation,” also commonly referred to more simply as a “locate operation” (or sometimes merely as “a locate”). In a typical locate operation, a locate technician visits a work site in which there is a plan to disturb the ground (e.g., excavate, dig one or more holes and/or trenches, bore, etc.) so as to determine a presence or an absence of one or more underground facilities (such as various types of utility cables and pipes) in a dig area to be excavated or disturbed at the work site. In some instances, a locate operation may be requested for a “design” project, in which there may be no immediate plan to excavate or otherwise disturb the ground, but nonetheless information about a presence or absence of one or more underground facilities at a work site may be valuable to inform a planning, permitting and/or engineering design phase of a future construction project.

In many states, an excavator who plans to disturb ground at a work site is required by law to notify any potentially affected underground facility owners prior to undertaking an excavation activity. Advanced notice of excavation activities may be provided by an excavator (or another party) by contacting a “one-call center.” One-call centers typically are operated by a consortium of underground facility owners for the purposes of receiving excavation notices and in turn notifying facility owners and/or their agents of a plan to excavate. As part of an advanced notification, excavators typically provide to the one-call center various information relating to the planned activity, including a location (e.g., address) of the work site and a description of the dig area to be excavated or otherwise disturbed at the work site.

A locate operation is initiated as a result of an excavator providing an excavation notice to a one-call center. An excavation notice also is commonly referred to as a “locate request,” and may be provided by the excavator to the one-call center via an electronic mail message, information entry via a website maintained by the one-call center, or a telephone conversation between the excavator and a human operator at the one-call center. The locate request may include an address or some other location-related information describing the geographic location of a work site at which the excavation is to be performed, as well as a description of the dig area (e.g., a text description), such as its location relative to certain landmarks and/or its approximate dimensions, within which there is a plan to disturb the ground at the work site. One-call centers similarly may receive locate requests for design projects (for which, as discussed above, there may be no immediate plan to excavate or otherwise disturb the ground).

Once facilities implicated by the locate request are identified by a one-call center, the one-call center generates a “locate request ticket” (also known as a “locate ticket,” or simply a “ticket”). The locate request ticket essentially constitutes an instruction to inspect a work site and typically identifies the work site of the proposed excavation or design and a description of the dig area, typically lists on the ticket all of the underground facilities that may be present at the work site (e.g., by providing a member code for the facility owner of an underground facility), and may also include various other information relevant to the proposed excavation or design (e.g., the name of the excavation company, a name of a property owner or party contracting the excavation company to perform the excavation, etc.). The one-call center sends the ticket to one or more underground facility owners and/or one or more locate service providers (who may be acting as contracted agents of the facility owners) so that they can conduct a locate and marking operation to verify a presence or absence of the underground facilities in the dig area. For example, in some instances, a given underground facility owner may operate its own fleet of locate technicians, in which case the one-call center may send the ticket to the underground facility owner. In other instances, a given facility owner may contract with a locate service provider to receive locate request tickets and perform a locate and marking operation in response to received tickets on their behalf.

Upon receiving the locate request, a locate service provider or a facility owner (hereafter referred to as a “ticket recipient”) may dispatch a locate technician to the work site of planned excavation to determine a presence or absence of one or more underground facilities in the dig area to be excavated or otherwise disturbed. A typical first step for the locate technician includes utilizing an underground facility “locate device,” which is an instrument or set of instruments (also referred to commonly as a “locate set”) for detecting facilities that are concealed in some manner, such as cables and pipes that are located underground. The locate device is employed by the technician to verify the presence or absence of underground facilities indicated in the locate request ticket as potentially present in the dig area (e.g., via the facility owner member codes listed in the ticket). This process is often referred to as a “locate operation.”

In one example of a locate operation, an underground facility locate device is used to detect electromagnetic fields that are generated by an applied signal provided along a length of a target facility to be identified. In this example, a locate device may include both a signal transmitter to provide the applied signal (e.g., which is coupled by the locate technician to a tracer wire disposed along a length of a facility), and a signal receiver which is generally a hand-held apparatus carried by the locate technician as the technician walks around the dig area to search for underground facilities. FIG. 1A illustrates conventional locate equipment 10 (indicated by the dashed box) that includes a transmitter 12 and a locate receiver 14. The transmitter 12 is connected, via a connection point 20, to a target object (in this example, underground facility 22) located in the ground 24. The transmitter generates the applied signal 26, which is coupled to the underground facility via the connection point (e.g., to a tracer wire along the facility), resulting in the generation of a magnetic field 28. The magnetic field in turn is detected by the locate receiver 14, which itself may include at least one detection antenna. The locate receiver 14 indicates a presence of a facility when it detects electromagnetic fields arising from the applied signal 26. Conversely, the absence of a signal detected by the locate receiver generally indicates the absence of the target facility.

In yet another example, a locate device employed for a locate operation may include a single instrument, similar in some respects to a conventional metal detector. In particular, such an instrument may include an oscillator to generate an alternating current that passes through a coil, which in turn produces a first magnetic field. If a piece of electrically conductive metal is in close proximity to the coil (e.g., if an underground facility having a metal component is below/near the coil of the instrument), eddy currents are induced in the metal and the metal produces its own magnetic field, which in turn affects the first magnetic field. The instrument may include a second coil to measure changes to the first magnetic field, thereby facilitating detection of metallic objects.

In addition to the locate operation, the locate technician also generally performs a “marking operation,” in which the technician marks the presence (and in some cases the absence) of a given underground facility in the dig area based on the various signals detected (or not detected) during the locate operation. For this purpose, the locate technician conventionally utilizes a “marking device” to dispense a marking material on, for example, the ground, pavement, or other surface along a detected underground facility. Marking material may be any material, substance, compound, and/or element, used or which may be used separately or in combination to mark, signify, and/or indicate. Examples of marking materials may include, but are not limited to, paint, chalk, dye, and/or iron. Marking devices, such as paint marking wands and/or paint marking wheels, provide a convenient method of dispensing marking materials onto surfaces, such as onto the surface of the ground or pavement.

FIGS. 1B and 1C illustrate a conventional marking device 50 with a mechanical actuation system to dispense paint as a marker. Generally speaking, the marking device 50 includes a handle 38 at a proximal end of an elongated shaft 36 and resembles a sort of “walking stick,” such that a technician may operate the marking device while standing/walking in an upright or substantially upright position. A marking dispenser holder 40 is coupled to a distal end of the shaft 36 so as to contain and support a marking dispenser 56, e.g., an aerosol paint can having a spray nozzle 54. Typically, a marking dispenser in the form of an aerosol paint can is placed into the holder 40 upside down, such that the spray nozzle 54 is proximate to the distal end of the shaft (close to the ground, pavement or other surface on which markers are to be dispensed).

In FIGS. 1B and 1C, the mechanical actuation system of the marking device 50 includes an actuator or mechanical trigger 42 proximate to the handle 38 that is actuated/triggered by the technician (e.g., via pulling, depressing or squeezing with fingers/hand). The actuator 42 is connected to a mechanical coupler 52 (e.g., a rod) disposed inside and along a length of the elongated shaft 36. The coupler 52 is in turn connected to an actuation mechanism 58, at the distal end of the shaft 36, which mechanism extends outward from the shaft in the direction of the spray nozzle 54. Thus, the actuator 42, the mechanical coupler 52, and the actuation mechanism 58 constitute the mechanical actuation system of the marking device 50.

FIG. 1B shows the mechanical actuation system of the conventional marking device 50 in the non-actuated state, wherein the actuator 42 is “at rest” (not being pulled) and, as a result, the actuation mechanism 58 is not in contact with the spray nozzle 54. FIG. 1C shows the marking device 50 in the actuated state, wherein the actuator 42 is being actuated (pulled, depressed, squeezed) by the technician. When actuated, the actuator 42 displaces the mechanical coupler 52 and the actuation mechanism 58 such that the actuation mechanism contacts and applies pressure to the spray nozzle 54, thus causing the spray nozzle to deflect slightly and dispense paint. The mechanical actuation system is spring-loaded so that it automatically returns to the non-actuated state (FIG. 1B) when the actuator 42 is released.

In some environments, arrows, flags, darts, or other types of physical marks may be used to mark the presence or absence of an underground facility in a dig area, in addition to or as an alternative to a material applied to the ground (such as paint, chalk, dye, tape) along the path of a detected utility. The marks resulting from any of a wide variety of materials and/or objects used to indicate a presence or absence of underground facilities generally are referred to as “locate marks.” Often, different color materials and/or physical objects may be used for locate marks, wherein different colors correspond to different utility types. For example, the American Public Works Association (APWA) has established a standardized color-coding system for utility identification for use by public agencies, utilities, contractors and various groups involved in ground excavation (e.g., red=electric power lines and cables; blue=portable water; orange=telecommunication lines; yellow=gas, oil, steam). In some cases, the technician also may provide one or more marks to indicate that no facility was found in the dig area (sometimes referred to as a “clear”).

As mentioned above, the foregoing activity of identifying and marking a presence or absence of one or more underground facilities generally is referred to for completeness as a “locate and marking operation.” However, in light of common parlance adopted in the construction industry, and/or for the sake of brevity, one or both of the respective locate and marking functions may be referred to in some instances simply as a “locate operation” or a “locate” (i.e., without making any specific reference to the marking function). Accordingly, it should be appreciated that any reference in the relevant arts to the task of a locate technician simply as a “locate operation” or a “locate” does not necessarily exclude the marking portion of the overall process. At the same time, in some contexts a locate operation is identified separately from a marking operation, wherein the former relates more specifically to detection-related activities and the latter relates more specifically to marking-related activities.

Inaccurate locating and/or marking of underground facilities can result in physical damage to the facilities, property damage, and/or personal injury during the excavation process that, in turn, can expose a facility owner or contractor to significant legal liability. When underground facilities are damaged and/or when property damage or personal injury results from damaging an underground facility during an excavation, the excavator may assert that the facility was not accurately located and/or marked by a locate technician, while the locate contractor who dispatched the technician may in turn assert that the facility was indeed properly located and marked. Proving whether the underground facility was properly located and marked can be difficult after the excavation (or after some damage, e.g., a gas explosion), because in many cases the physical locate marks (e.g., the marking material or other physical marks used to mark the facility on the surface of the dig area) will have been disturbed or destroyed during the excavation process (and/or damage resulting from excavation).

Underground facility locate service providers (hereafter referred to as locate companies) conduct training programs and/or other processes for training newly hired locate technicians and/or updating or certifying the skills of locate technicians. For example, locate companies may conduct training exercises over a period of days and/or weeks. Further, locate companies may provide ongoing training and/or certification exercises for all locate technicians due to, for example, changes in policies and/or technology with respect to performing locate operations. These training and/or other processes require planning and resources (i.e., monetary, physical, and/or human resources). As a result, locate companies may have a significant investment with respect to programs and/or other processes for training new locate technicians and/or updating or certifying the skills of locate technicians.

Further, there may be inefficiencies and other drawbacks to current training programs and/or other processes for updating or certifying the skills of locate technicians. In one example, the content of the training, updating, and/or certification programs may be inconsistent from one session to another because of different instructors. Consequently, the outcome of the programs may be inconsistent. Therefore, a need exists for improved training, updating, and/or certification processes for locate technicians that provide consistent content and, therefore, provide consistent outcomes, are readily available, low cost, efficient, suitable for providing individual training as well as group training, and so on.

### SUMMARY

The present invention relates to training systems for, and methods of, simulating locate operations for training and/or skills evaluation. Facility locating equipment, such as on-site computers and/or locate receivers, may include modules for electronically simulating locate operations. Locating equipment including simulation modules may be used, for example, in locate technician training processes and/or for updating and/or evaluating the skills of locate technicians. In particular, a simulation module is provided for electronically generating “virtual” facilities, the presence and/or absence of which may be indicated to a locate technician during, for example, a training exercise. The actions of the locate technicians with respect to dispensing marking material that corresponds to the presence and/or absence of the virtual facilities are electronically captured, stored, and evaluated.

The training systems for and methods of simulating locate operations of the present invention may provide an improved training, updating, and/or certification mechanism which presents consistent content to locate technicians and which results in consistent outcomes.

The training systems for and methods of simulating locate operations of the present invention are readily available and suitable for providing individual training as well as group training, thereby reducing or eliminating scheduling and class size constraints.

The training systems for and methods of simulating locate operations of the present invention provide a low cost training, updating, and/or certification mechanism. For example, training exercises using the training systems and methods may be performed anywhere, thereby eliminating the need for a dedicated training environment and/or other dedicated resources. Thus, the training and/or skills evaluation methods of the present invention are independent of location and environment.

According to a first aspect of the invention, a method is provided for simulating a locate operation to locate the presence or absence of an underground facility in a dig area. The method comprises loading selected virtual facilities data into a virtual facilities memory in locate equipment, the selected virtual facilities data including geographic coordinates in the dig area and corresponding simulated signal values; sensing current geographic coordinates of the locate equipment with a location tracking device; accessing simulated signal values in the virtual facilities memory according to the sensed geographic coordinates of the locate equipment; and indicating the simulated signal values to a user.

According to a second aspect of the invention, a method is provided for controlling a simulated locate operation to locate the presence or absence of an underground facility in a dig area. The method comprises sending information representative of selected virtual facilities data to locate equipment; receiving marking data representative of a marking operation based on the selected virtual facilities data, the marking data being received from a marking device and including geographic coordinates of the marking device and corresponding marking device actuation data; and processing the received marking data and the selected virtual facilities data to provide an evaluation of the simulated locate operation.

According to a third aspect of the invention, a locate receiver is provided for simulating a locate operation to locate the presence or absence of an underground facility in a dig area. The locate receiver comprises a location tracking device to sense current geographic coordinates of the locate receiver; a virtual facilities memory to store selected virtual facilities data, the selected virtual facilities data including geographic coordinates and corresponding simulated signal values; a memory access module to access simulated signal values in the virtual facilities memory according to the sensed geographic coordinates of the locate receiver; and a user interface to indicate the accessed signal values to a user.

According to a fourth aspect of the invention, a training controller is provided to control a simulated locate operation to locate the presence or absence of an underground facility in a dig area. The training controller comprises a control module to send information representative of selected virtual facilities data to a locate receiver; a simulation data memory module to receive and store marking data representative of a marking operation based on the selected virtual facilities data; and a simulation evaluation module to process the received marking data and the selected virtual facilities data to provide an evaluation of the simulated locate operation.

According to a fifth aspect of the invention, a training system is provided for simulating a locate operation to locate the presence or absence of an underground facility in a dig area. The training system comprises a training controller configured to send information representative of selected virtual facilities data to a locate receiver, to receive marking data representative of a marking operation based on the selected virtual facilities data and to process the received marking data and the selected virtual facilities data to provide an evaluation of the simulated locate operation; a locate receiver configured to load the selected virtual facilities data into a virtual facilities memory, the virtual facilities data including geographic coordinates and corresponding simulated signal values, to sense current geographic coordinates of the locate receiver with a location tracking device, to access signal values in the virtual facilities memory according to the sensed geographic coordinates of the locate receiver, and to indicate the accessed signal values to a user; and a marking device configured to receive marking device actuations from a user based on the accessed signal values indicated to the user and to send marking data to the training controller, the marking data including geographic coordinates of the marking device and the corresponding marking device actuation data.

According to a sixth aspect of the invention, a method is provided for training a locate technician to perform a locate operation to locate the presence or absence of an underground facility in a dig area. The method comprises selecting, in a training controller, virtual facilities data for training; sending the selected virtual facilities data from the training controller to locate equipment; loading the selected virtual facilities data into a virtual facilities memory in the locate equipment; sensing current geographic coordinates of the locate equipment with a location tracking device; accessing signal values in the virtual facilities memory according to the sensed geographic coordinates of the locate equipment; indicating the accessed signal values to the locate technician; receiving, by a marking device, actuations by the locate technician based on the indicated signal values; generating, by the marking device, marking data based on the received actuations; sending the marking data from the marking device to the training controller; and processing, by the training controller, the marking data and the selected virtual facilities data to provide an evaluation of the simulated locate operation.

According to a seventh aspect of the invention, a method is provided for generating a virtual facilities file containing virtual facilities representative of underground facilities in a dig area. The method comprises defining tolerances with respect to locate operations using the virtual facilities; defining a complexity level of the virtual facilities; defining a size of a virtual area containing the virtual facilities; defining a reference point of the virtual area of the virtual facilities; defining the number and types of virtual facilities; defining positions of the virtual facilities with respect to the reference point; defining the depths of the virtual facilities; and saving the defined virtual facilities in a virtual facilities file for use during a simulated locate operation.

Glossary:

For purposes of the present disclosure, the term “dig area” refers to a specified area of a work site within which there is a plan to disturb the ground (e.g., excavate, dig holes and/or trenches, bore, etc.), and beyond which there is no plan to excavate in the immediate surroundings. Thus, the metes and bounds of a dig area are intended to provide specificity as to where some disturbance to the ground is planned at a given work site. It should be appreciated that a given work site may include multiple dig areas.

The term “facility” refers to one or more lines, cables, fibers, conduits, transmitters, receivers, or other physical objects or structures capable of or used for carrying, transmitting, receiving, storing, and providing utilities, energy, data, substances, and/or services, and/or any combination thereof. The term “underground facility” means any facility beneath the surface of the ground. Examples of facilities include, but are not limited to, oil, gas, water, sewer, power, telephone, data transmission, cable television (TV), and/or internet services.

The term “locate device” refers to any apparatus and/or device for detecting and/or inferring the presence or absence of any facility, including without limitation, any underground facility. In various examples, a locate device may include both a locate transmitter and a locate receiver (which in some instances may also be referred to collectively as a “locate instrument set,” or simply “locate set”).

The term “marking device” refers to any apparatus, mechanism, or other device that employs a marking dispenser for causing a marking material and/or marking object to be dispensed, or any apparatus, mechanism, or other device for electronically indicating (e.g., logging in memory) a location, such as a location of an underground facility. Additionally, the term “marking dispenser” refers to any apparatus, mechanism, or other device for dispensing and/or otherwise using, separately or in combination, a marking material and/or a marking object. An example of a marking dispenser may include, but is not limited to, a pressurized can of marking paint. The term “marking material” means any material, substance, compound, and/or element, used or which may be used separately or in combination to mark, signify, and/or indicate. Examples of marking materials may include, but are not limited to, paint, chalk, dye, and/or iron. The term “marking object” means any object and/or objects used or which may be used separately or in combination to mark, signify, and/or indicate. Examples of marking objects may include, but are not limited to, a flag, a dart, and arrow, and/or an RFID marking ball. It is contemplated that marking material may include marking objects. It is further contemplated that the terms “marking materials” or “marking objects” may be used interchangeably in accordance with the present disclosure.

The term “locate mark” means any mark, sign, and/or object employed to indicate the presence or absence of any underground facility. Examples of locate marks may include, but are not limited to, marks made with marking materials, marking objects, global positioning or other information, and/or any other means. Locate marks may be represented in any form including, without limitation, physical, visible, electronic, and/or any combination thereof.

The terms “actuate” or “trigger” (verb form) are used interchangeably to refer to starting or causing any device, program, system, and/or any combination thereof to work, operate, and/or function in response to some type of signal or stimulus. Examples of actuation signals or stimuli may include, but are not limited to, any local or remote, physical, audible, inaudible, visual, non-visual, electronic, mechanical, electromechanical, biomechanical, biosensing or other signal, instruction, or event. The terms “actuator” or “trigger” (noun form) are used interchangeably to refer to any method or device used to generate one or more signals or stimuli to cause or causing actuation. Examples of an actuator/trigger may include, but are not limited to, any form or combination of a lever, switch, program, processor, screen, microphone for capturing audible commands, and/or other device or method. An actuator/trigger may also include, but is not limited to, a device, software, or program that responds to any movement and/or condition of a user, such as, but not limited to, eye movement, brain activity, heart rate, other data, and/or the like, and generates one or more signals or stimuli in response thereto. In the case of a marking device or other marking mechanism (e.g., to physically or electronically mark a facility or other feature), actuation may cause marking material to be dispensed, as well as various data relating to the marking operation (e.g., geographic location, time stamps, characteristics of material dispensed, etc.) to be logged in an electronic file stored in memory. In the case of a locate device or other locate mechanism (e.g., to physically locate a facility or other feature), actuation may cause a detected signal strength, signal frequency, depth, or other information relating to the locate operation to be logged in an electronic file stored in memory.

The terms “locate and marking operation,” “locate operation,” and “locate” generally are used interchangeably and refer to any activity to detect, infer, and/or mark the presence or absence of an underground facility. In some contexts, the term “locate operation” is used to more specifically refer to detection of one or more underground facilities, and the term “marking operation” is used to more specifically refer to using a marking material and/or one or more marking objects to mark a presence or an absence of one or more underground facilities. The term “locate technician” refers to an individual performing a locate operation. A locate and marking operation often is specified in connection with a dig area, at least a portion of which may be excavated or otherwise disturbed during excavation activities.

The term “user” refers to an individual utilizing a locate device and/or a marking device and may include, but is not limited to, land surveyors, locate technicians, and support personnel.

The terms “locate request” and “excavation notice” are used interchangeably to refer to any communication to request a locate and marking operation. The term “locate request ticket” (or simply “ticket”) refers to any communication or instruction to perform a locate operation. A ticket might specify, for example, the address or description of a dig area to be marked, the day and/or time that the dig area is to be marked, and/or whether the user is to mark the excavation area for certain gas, water, sewer, power, telephone, cable television, and/or some other underground facility. The term “historical ticket” refers to past tickets that have been completed.

The following U.S. published applications are hereby incorporated herein by reference:
U.S. Pat. No. 7,640,105, issued Dec. 29, 2009, filed Mar. 13, 2007, and entitled “Marking System and Method With Location and/or Time Tracking”;
U.S. publication no. 2010-0094553-A1, published Apr. 15, 2010, filed Dec. 16, 2009, and entitled “Systems and Methods for Using Location Data and/or Time Data to Electronically Display Dispensing of Markers by A Marking System or Marking Tool”;
U.S. publication no. 2008-0245299-A1, published Oct. 9, 2008, filed Apr. 4, 2007, and entitled “Marking System and Method”;
U.S. publication no. 2009-0013928-A1, published Jan. 15, 2009, filed Sep. 24, 2008, and entitled “Marking System and Method”;
U.S. publication no. 2010-0090858-A1, published Apr. 15, 2010, filed Dec. 16, 2009, and entitled “Systems and Methods for Using Marking Information to Electronically Display Dispensing of Markers by a Marking System or Marking Tool”;
U.S. publication no. 2009-0238414-A1, published Sep. 24, 2009, filed Mar. 18, 2008, and entitled “Virtual White Lines for Delimiting Planned Excavation Sites”;
U.S. publication no. 2009-0241045-A1, published Sep. 24, 2009, filed Sep. 26, 2008, and entitled “Virtual White Lines for Delimiting Planned Excavation Sites”;
U.S. publication no. 2009-0238415-A1, published Sep. 24, 2009, filed Sep. 26, 2008, and entitled “Virtual White Lines for Delimiting Planned Excavation Sites”;
U.S. publication no. 2009-0241046-A1, published Sep. 24, 2009, filed Jan. 16, 2009, and entitled “Virtual White Lines for Delimiting Planned Excavation Sites”;
U.S. publication no. 2009-0238416-A1, published Sep. 24, 2009, filed Jan. 16, 2009, and entitled “Virtual White Lines for Delimiting Planned Excavation Sites”;
U.S. publication no. 2009-0237408-A1, published Sep. 24, 2009, filed Jan. 16, 2009, and entitled “Virtual White Lines for Delimiting Planned Excavation Sites”;
U.S. publication no. 2009-0202101-A1, published Aug. 13, 2009, filed Feb. 12, 2008, and entitled “Electronic Manifest of Underground Facility Locate Marks”;
U.S. publication no. 2009-0202110-A1, published Aug. 13, 2009, filed Sep. 11, 2008, and entitled “Electronic Manifest of Underground Facility Locate Marks”;
U.S. publication no. 2009-0201311-A1, published Aug. 13, 2009, filed Jan. 30, 2009, and entitled “Electronic Manifest of Underground Facility Locate Marks”;
U.S. publication no. 2009-0202111-A1, published Aug. 13, 2009, filed Jan. 30, 2009, and entitled “Electronic Manifest of Underground Facility Locate Marks”;
U.S. publication no. 2009-0204625-A1, published Aug. 13, 2009, filed Feb. 5, 2009, and entitled “Electronic Manifest of Underground Facility Locate Operation”;
U.S. publication no. 2009-0204466-A1, published Aug. 13, 2009, filed Sep. 4, 2008, and entitled “Ticket Approval System For and Method of Performing Quality Control In Field Service Applications”;
U.S. publication no. 2009-0207019-A1, published Aug. 20, 2009, filed Apr. 30, 2009, and entitled “Ticket Approval System For and Method of Performing Quality Control In Field Service Applications”;
U.S. publication no. 2009-0210284-A1, published Aug. 20, 2009, filed Apr. 30, 2009, and entitled “Ticket Approval System For and Method of Performing Quality Control In Field Service Applications”;
U.S. publication no. 2009-0210297-A1, published Aug. 20, 2009, filed Apr. 30, 2009, and entitled “Ticket Approval System For and Method of Performing Quality Control In Field Service Applications”;
U.S. publication no. 2009-0210298-A1, published Aug. 20, 2009, filed Apr. 30, 2009, and entitled “Ticket Approval System For and Method of Performing Quality Control In Field Service Applications”;
U.S. publication no. 2009-0210285-A1, published Aug. 20, 2009, filed Apr. 30, 2009, and entitled “Ticket Approval System For and Method of Performing Quality Control In Field Service Applications”;
U.S. publication no. 2009-0324815-A1, published Dec. 31, 2009, filed Apr. 24, 2009, and entitled “Marking Apparatus and Marking Methods Using Marking Dispenser with Machine-Readable ID Mechanism”;
U.S. publication no. 2010-0006667-A1, published Jan. 14, 2010, filed Apr. 24, 2009, and entitled, “Marker Detection Mechanisms for use in Marking Devices And Methods of Using Same”;
U.S. publication no. 2010-0085694 A1, published Apr. 8, 2010, filed Sep. 30, 2009, and entitled, “Marking Device Docking Stations and Methods of Using Same”;
U.S. publication no. 2010-0085701 A1, published Apr. 8, 2010, filed Sep. 30, 2009, and entitled, “Marking Device Docking Stations Having Security Features and Methods of Using Same”;
U.S. publication no. 2010-0084532 A1, published Apr. 8, 2010, filed Sep. 30, 2009, and entitled, “Marking Device Docking Stations Having Mechanical Docking and Methods of Using Same”;
U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same”;
U.S. publication no. 2010-0117654 A1, published May 13, 2010, filed Dec. 30, 2009, and entitled, “Methods and Apparatus for Displaying an Electronic Rendering of a Locate and/or Marking Operation Using Display Layers”;
U.S. publication no. 2010-0086677 A1, published Apr. 8, 2010, filed Aug. 11, 2009, and entitled, “Methods and Apparatus for Generating an Electronic Record of a Marking Operation Including Service-Related Information and Ticket Information”;
U.S. publication no. 2010-0086671 A1, published Apr. 8, 2010, filed Nov. 20, 2009, and entitled, “Methods and Apparatus for Generating an Electronic Record of A Marking Operation Including Service-Related Information and Ticket Information”;
U.S. publication no. 2010-0085376 A1, published Apr. 8, 2010, filed Oct. 28, 2009, and entitled, “Methods and Apparatus for Displaying an Electronic Rendering of a Marking Operation Based on an Electronic Record of Marking Information”;
U.S. publication no. 2010-0088164-A1, published Apr. 8, 2010, filed Sep. 30, 2009, and entitled, “Methods and Apparatus for Analyzing Locate and Marking Operations with Respect to Facilities Maps”;
U.S. publication no. 2010-0088134 A1, published Apr. 8, 2010, filed Oct. 1, 2009, and entitled, “Methods and Apparatus for Analyzing Locate and Marking Operations with Respect to Historical Information”;
U.S. publication no. 2010-0088031 A1, published Apr. 8, 2010, filed Sep. 28, 2009, and entitled, “Methods and Apparatus for Generating an Electronic Record of Environmental Landmarks Based on Marking Device Actuations”;
U.S. publication no. 2009-0204238-A1, published Aug. 13, 2009, filed Feb. 2, 2009, and entitled “Electronically Controlled Marking Apparatus and Methods”;
U.S. publication no. 2009-0208642-A1, published Aug. 20, 2009, filed Feb. 2, 2009, and entitled “Marking Apparatus and Methods For Creating an Electronic Record of Marking Operations”;
U.S. publication no. 2009-0210098-A1, published Aug. 20, 2009, filed Feb. 2, 2009, and entitled “Marking Apparatus and Methods For Creating an Electronic Record of Marking Apparatus Operations”;
U.S. publication no. 2009-0201178-A1, published Aug. 13, 2009, filed Feb. 2, 2009, and entitled “Methods For Evaluating Operation of Marking Apparatus”;
U.S. publication no. 2009-0238417-A1, published Sep. 24, 2009, filed Feb. 6, 2009, and entitled “Virtual White Lines for Indicating Planned Excavation Sites on Electronic Images”;
U.S. publication no. 2009-0202112-A1, published Aug. 13, 2009, filed Feb. 11, 2009, and entitled “Searchable Electronic Records of Underground Facility Locate Marking Operations”;
U.S. publication no. 2009-0204614-A1, published Aug. 13, 2009, filed Feb. 11, 2009, and entitled “Searchable Electronic Records of Underground Facility Locate Marking Operations”;
U.S. publication no. 2009-0327024-A1, published Dec. 31, 2009, filed Jun. 26, 2009, and entitled “Methods and Apparatus for Quality Assessment of a Field Service Operation”;
U.S. publication no. 2010-0010862-A1, published Jan. 14, 2010, filed Aug. 7, 2009, and entitled, “Methods and Apparatus for Quality Assessment of a Field Service Operation Based on Geographic Information”;
U.S. publication No. 2010-0010863-A1, published Jan. 14, 2010, filed Aug. 7, 2009, and entitled, “Methods and Apparatus for Quality Assessment of a Field Service Operation Based on Multiple Scoring Categories”;
U.S. publication no. 2010-0010882-A1, published Jan. 14, 2010, filed Aug. 7, 2009, and entitled, “Methods and Apparatus for Quality Assessment of a Field Service Operation Based on Dynamic Assessment Parameters”;
U.S. publication no. 2010-0010883-A1, published Jan. 14, 2010, filed Aug. 7, 2009, and entitled, “Methods and Apparatus for Quality Assessment of a Field Service Operation Based on Multiple Quality Assessment Criteria”;
U.S. publication no. 2010-0088135 A1, published Apr. 8, 2010, filed Oct. 1, 2009, and entitled, “Methods and Apparatus for Analyzing Locate and Marking Operations with Respect to Environmental Landmarks”;
U.S. publication no. 2010-0085185 A1, published Apr. 8, 2010, filed Sep. 30, 2009, and entitled, “Methods and Apparatus for Generating Electronic Records of Locate Operations”;
U.S. publication no. 2010-0090700-A1, published Apr. 15, 2010, filed Oct. 30, 2009, and entitled “Methods and Apparatus for Displaying an Electronic Rendering of a Locate Operation Based on an Electronic Record of Locate Information”; and
U.S. publication no. 2010-0085054 A1, published Apr. 8, 2010, filed Sep. 30, 2009, and entitled, “Systems and Methods for Generating Electronic Records of Locate And Marking Operations.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The present invention, both as to its organization and manner of operation, together with further objectives and advantages, may be best understood by reference to the following description, taken in connection with the accompanying drawings as set forth below:

FIG. 1A illustrates a conventional locate transmitter and locate receiver;

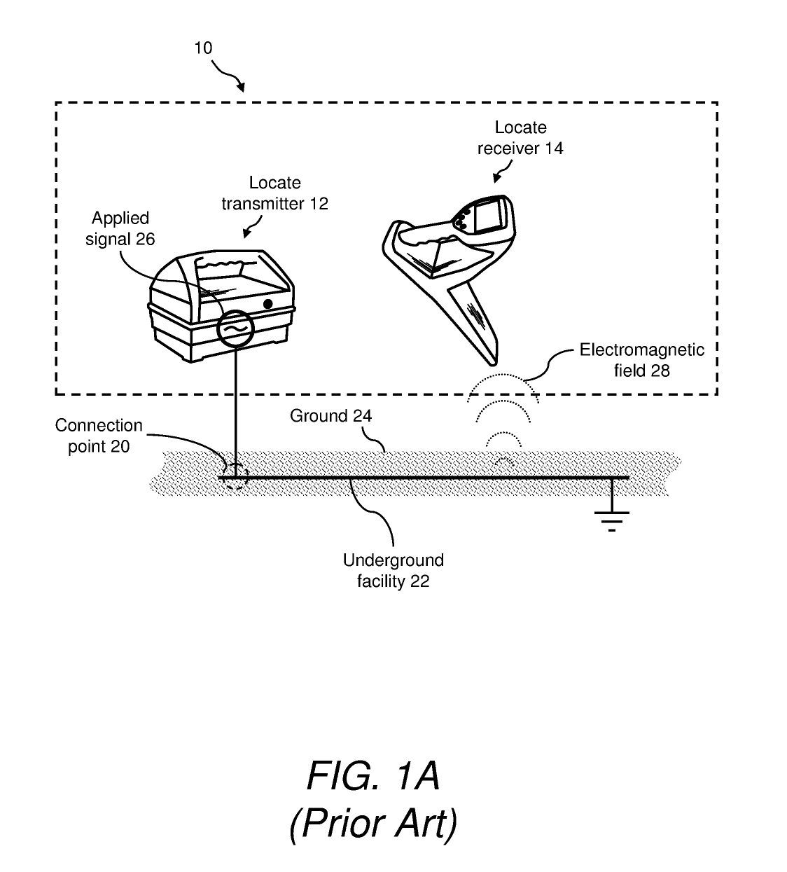

FIGS. 1B and 1C illustrate a conventional marking device in non-actuated and actuated states, respectively;

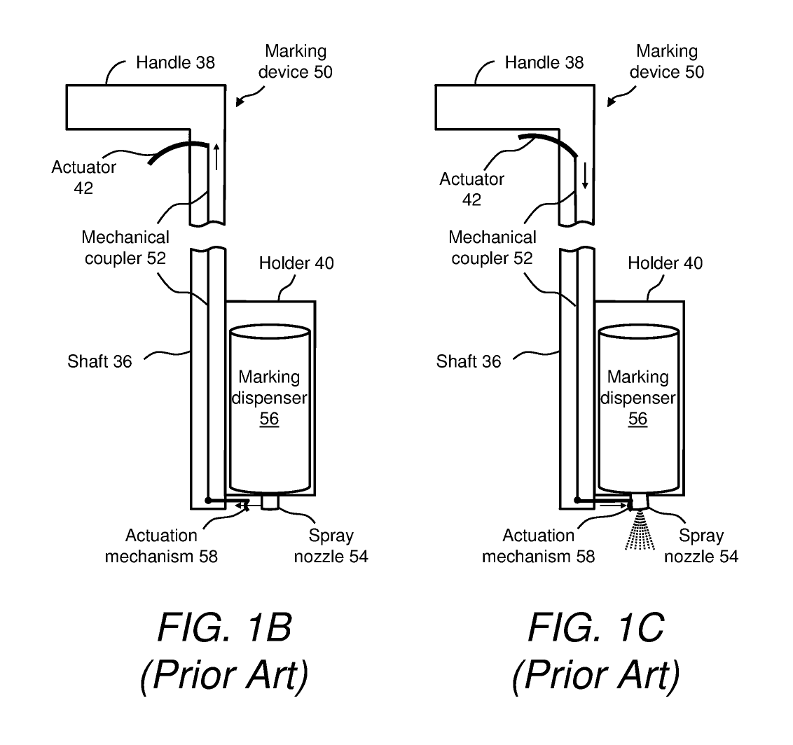

FIG. 2 is a functional block diagram of a training system for simulating a locate operation, in accordance with embodiments of the invention;

FIG. 3 is a pictorial diagram of the training system of FIG. 2, in accordance with embodiments of the invention;

FIG. 4 is a pictorial diagram of a locate receiver equipped with a receiver locate simulation module, in accordance with embodiments of the invention;

FIG. 5 is a functional block diagram of the locate receiver of FIG. 4, in accordance with embodiments of the invention;

FIG. 5A is a functional block diagram of the receiver locate simulation module of FIG. 5, in accordance with embodiments of the invention;

FIG. 6 is a functional block diagram of the training computer of FIGS. 2 and 3, in accordance with embodiments of the invention;

FIG. 6A is a functional block diagram of the host locate simulation module of FIG. 6, in accordance with embodiments of the invention;

FIG. 7 is a pictorial view of a marking device that may be used in the training system of FIGS. 2 and 3, in accordance with embodiments of the invention;

FIG. 7A is a functional block diagram of the marking device of FIG. 7, in accordance with embodiments of the invention;

FIG. 8 is a top view of an example of virtual facilities that may be utilized for training, in accordance with embodiments of the invention;

FIG. 9 is a flow diagram of locate receiver operation during a simulated locate operation, in accordance with embodiments of the invention;

FIG. 10 is a flow diagram of a marking device operation during a simulated locate operation, in accordance with embodiments of the invention;

FIG. 11 is a pictorial diagram of a marking device dispensing a dotting pattern to mark a virtual underground facility during a simulated locate operation;

FIG. 12 is a pictorial diagram of a marking device dispensing a line pattern to mark a virtual underground facility during a simulated locate operation;

FIG. 13 is a flow diagram of training computer operation during a simulated locate operation, in accordance with embodiments of the invention;

FIG. 14 is a top view of marking data superimposed on virtual facilities data, in accordance with embodiments of the invention; and

FIG. 15 is a diagram of a method for generating virtual facilities, in accordance with embodiments of the invention.

### DETAILED DESCRIPTION

The present invention relates to training systems for and methods of simulating locate operations for training and/or skills evaluation. Facility locating equipment, such as on-site computers and/or locate receivers may include modules for electronically simulating locate operations. Locating equipment including simulation modules may be used, for example, in locate technician training processes and/or for updating and/or evaluating the skills of locate technicians. In particular, a simulation module is provided for electronically generating “virtual” facilities, the presence and/or absence of which may be indicated to a locate technician during, for example, a training exercise. The actions of the locate technicians with respect to dispensing marking material that corresponds to the presence and/or absence of the virtual facilities are electronically captured, stored, and evaluated.

The training systems for and methods of simulating locate operations of the present invention may provide an improved training, updating, and/or certification mechanism which presents consistent content to locate technicians and which results in consistent outcomes.

The training systems for and methods of simulating locate operations of the present invention are readily available and suitable for providing individual training as well as group training, thereby reducing or eliminating scheduling and class size constraints.

The training systems for and methods of simulating locate operations of the present invention provide a low cost training, updating, and/or certification mechanism. For example, training exercises using the training systems and methods may be performed anywhere, thereby eliminating the need for a dedicated training environment and/or other dedicated resources. Thus, the training and/or skills evaluation methods of the present invention are independent of location and environment.

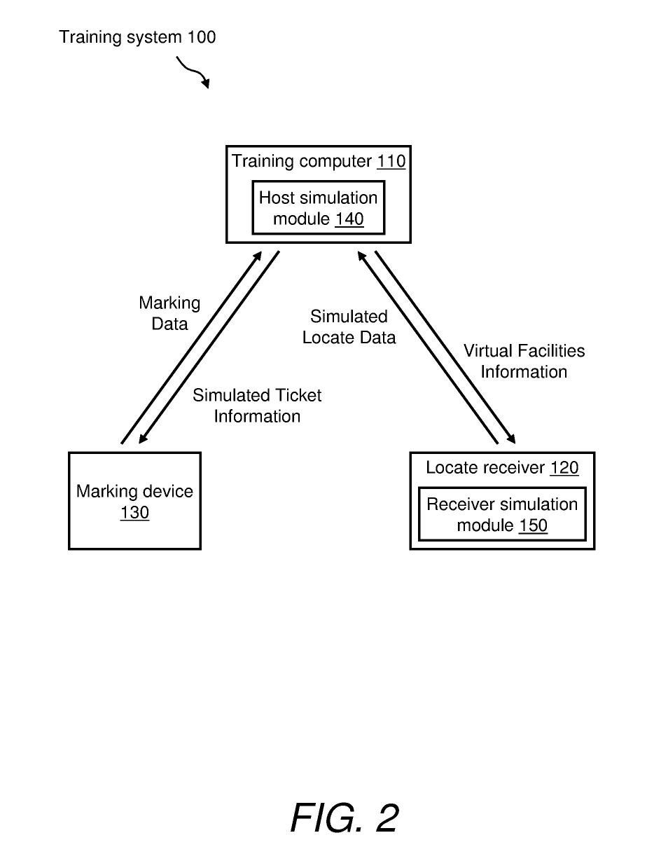

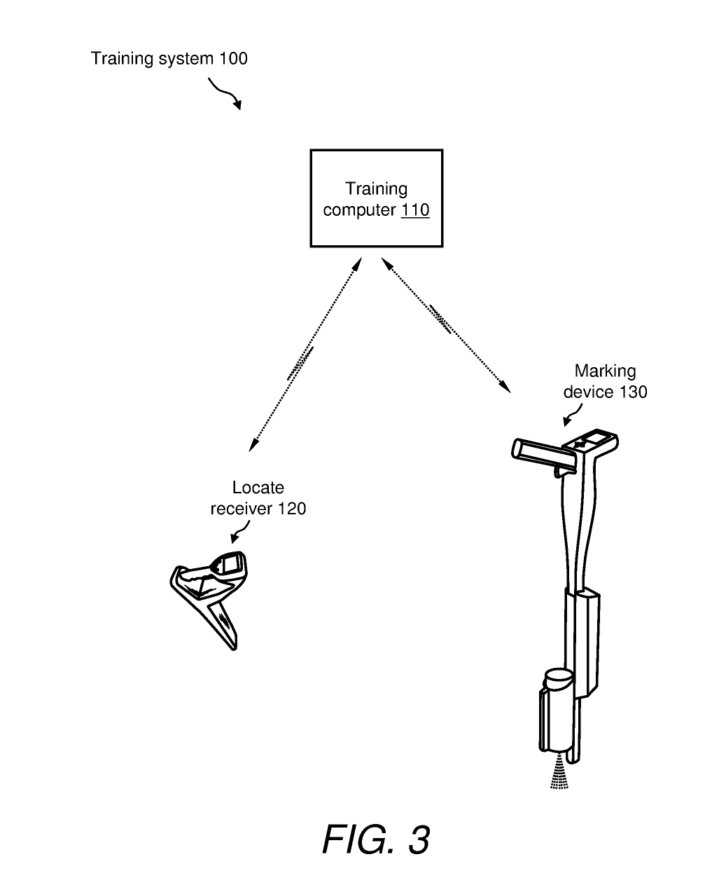

A block diagram of a training system including simulation modules for simulating locate operations is shown in FIG. 2. A pictorial diagram of the training system is shown in FIG. 3. A training system 100 includes a training computer 110, a locate receiver 120 and a marking device 130. The training computer 110 may communicate with locate receiver 120 and with marking device 130 by wireless communication. The training computer 110 may include a host simulation module 140 for controlling and evaluating simulated locate operations. The locate receiver 120 may include a receiver simulation module 150 for simulating the operation of a locate receiver based on selected virtual facilities, as described below. Marking device 130 may be an electronic, geo-enabled marking device, but in this embodiment does not include a simulation module. In other embodiments, marking device 130 may include a simulation module to enable aspects of the simulated locate operation.

As shown in FIG. 2, training computer 110 may send virtual facilities information to locate receiver 120. The virtual facilities information may include selected virtual facilities data or may identify selected virtual facilities data stored in locate receiver 120. Locate receiver 120 may send simulated locate data to training computer 110 for evaluation. The simulated locate data may include a record of the simulated locate operation performed by locate receiver 120, including, but not limited to, sensed geographic coordinates, simulated signal strength values and timestamps. The training computer 110 may send simulated ticket information to marking device 130. The simulated ticket information may simulate an actual locate request ticket that is used for a locate operation. The marking device 130 sends marking data to training computer 110. The marking data reflects the marking performed by the locate technician during the training exercise in response to the simulated signal strength values generated by the receiver simulation module 150 in locate receiver 120.

Simulation modules 140 and 150 are software modules for controlling the simulated locate operations of the present invention. For example, simulation modules 140 and 150 may generate an arrangement of “virtual” facilities, the presence and/or absence of which may be indicated to a locate technician during a training, updating, and/or certification exercise. The virtual facilities that are generated by simulation modules 140 and 150 eliminate the need for actual underground facilities to be present during locate technician training, updating, and/or certification exercises. As a result, these exercises may occur in any geographic location and environment. Because virtual facilities are generated by simulation modules 140 and 150, the locating equipment for and methods of simulating locate operations of the present invention are independent of geographic location and environment.

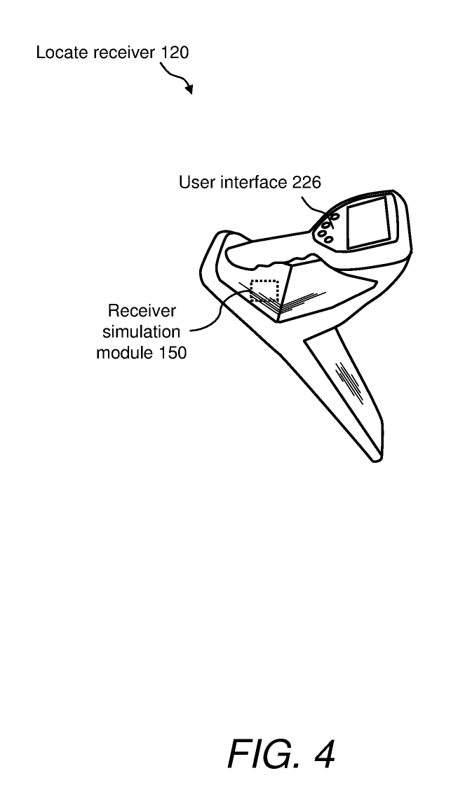

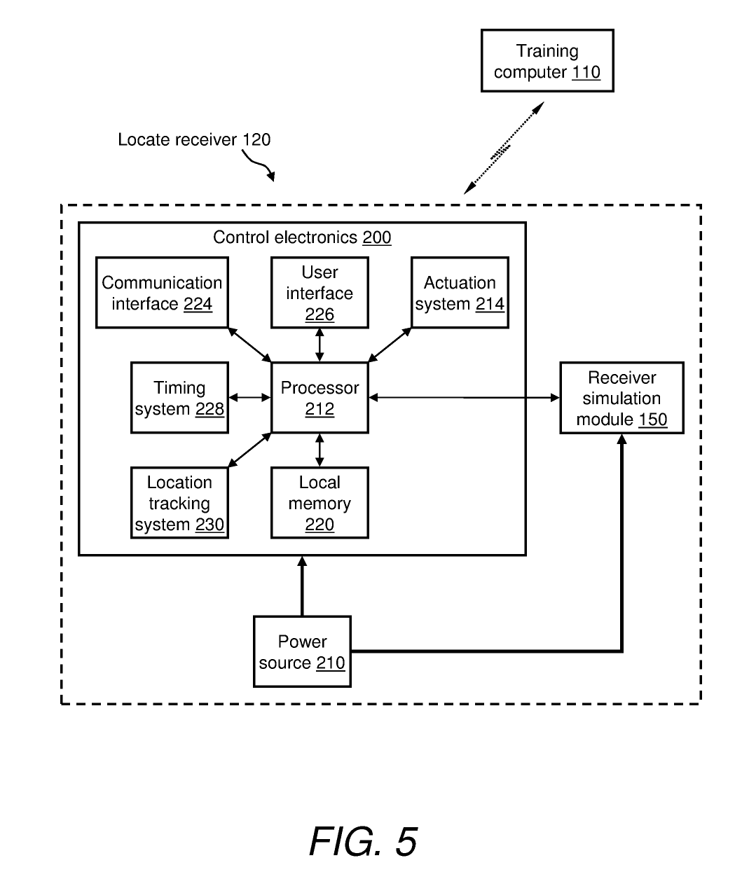

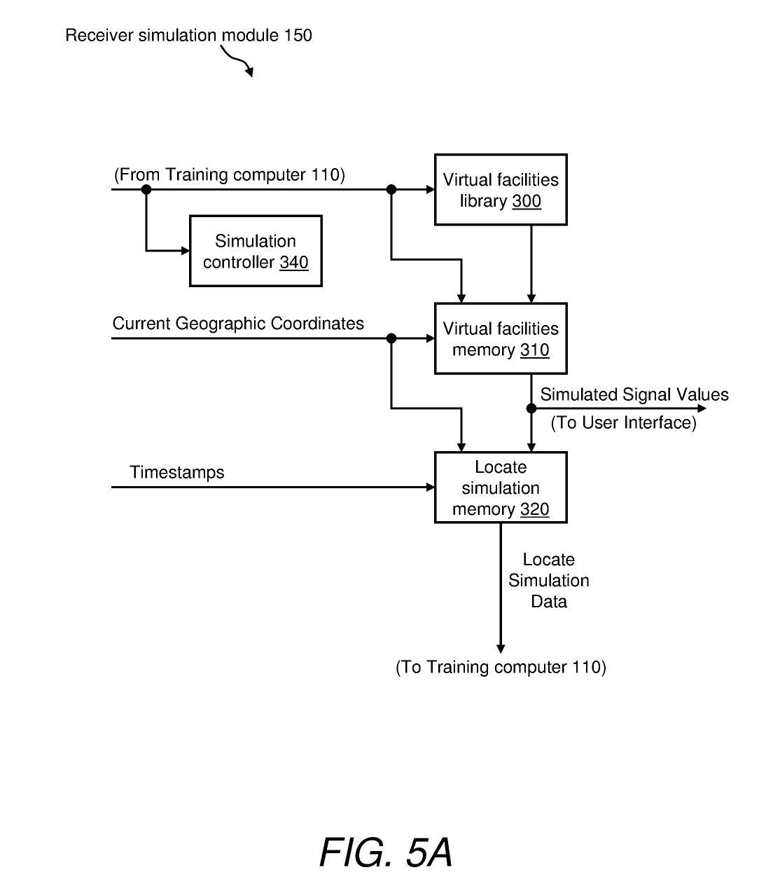

Preferably, locate receiver device 120 is, for example, an electronic, geo-enabled locate receiver device. The locate receiver device may include, but is not limited to, components for capturing information about the detection signal strength and frequency, as well as facility depth; components for capturing information about environmental conditions; components for capturing information about the position, orientation, and movement of the locating equipment; and components for capturing image and audio information about locate operations. Details of an example of an electronic, geo-enabled locate receiver device are described with reference to FIGS. 4, 5 and 5A. In some embodiments, the detection electronics of locate receiver 120 can be omitted. Electronic, geo-enabled locate receivers are described, for example, in U.S. patent application Ser. No. 12/704,087, filed Feb. 11, 2010 and entitled “Locate Apparatus Having Enhanced Features for Underground Facility Locate Operations, and Associated Methods and Systems.” which is incorporated herein by reference.

A pictorial diagram of locate receiver 120 is shown in FIG. 4, and a block diagram of locate receiver 120 is shown in FIG. 5. As shown in FIG. 5, in one embodiment locate receiver 120 includes control electronics 200, receiver simulation module 150 and power source 210. The components of control electronics 200 and receiver simulation module 150 are powered by power source 210. Power source 210 may be any power source that is suitable for use in a portable device, such as, but not limited to, one or more rechargeable batteries, one or more non-rechargeable batteries, a solar photovoltaic panel, a standard AC power plug feeding an AC-to-DC converter, and the like.

The locate receiver 120 shown in FIG. 5 does not include detection electronics, normally included a locate receiver, to detect electromagnetic fields produced by an underground facility. Thus, the locate receiver 120 is dedicated to training applications where the receiver simulation module 150 is utilized. In other embodiments, the locate receiver may include both detection electronics and a receiver simulation module. In such embodiments, the locate receiver may be used both for training operations and for actual locate operations.

As also shown in FIG. 5, in one embodiment control electronics 200 of locate receiver 120 may include, but is not limited to, a processor 212, at least a portion of an actuation system 214 (another portion of which may include one or more mechanical elements), a local memory 220, a communication interface 224, a user interface 226, a timing system 228, and a location tracking system 230.

The processor 212 may be any general-purpose processor, controller, or microcontroller device. Local memory 220 may be any volatile or non-volatile data storage device, such as, but not limited to, a random access memory (RAM) device and a removable memory device (e.g., a universal serial bus (USB) flash drive, a multimedia card (MMC), a secure digital card (SD), a compact flash card (CF), etc.). As discussed further below, the local memory may store a locate data algorithm, which may be a set of processor-executable instructions that when executed by the processor 212 causes the processor to control various other components of the locate receiver 120 so as to generate an electronic record of a locate operation, which record also may be stored in the local memory 220 and/or transmitted in essentially real-time (as it is being generated) or after completion of a locate operation to a remote device (e.g., training computer 110).

In one exemplary implementation, a Linux-based processing system for embedded handheld and/or wireless devices may be employed in the locate receiver 120 to implement various components of the control electronics 200. For example, the Fingertip4™ processing system, including a Marvell PXA270 processor and available from InHand Electronics, Inc. (www.inhandelectronics.com/products/fingertip4), may be used. In addition to the PXA270 processor (e.g., serving as the processor 212), the Fingertip4™ includes flash memory and SDRAM (e.g., serving as local memory 220), multiple serial ports, a USB port, and other I/O interfaces (e.g., to facilitate interfacing with one or more input devices and other components of the locate receiver), supports a variety of wired and wireless interfaces (WiFi, Bluetooth®, GPS, Ethernet, any IEEE 802.11 interface, or any other suitable wireless interface) to facilitate implementation of the communication interface 224, and connects to a wide variety of LCD displays (to facilitate implementation of a user interface/display). In yet other exemplary implementations, the processor 212 may be realized by multiple processors that divide/share some or all of the functionality discussed herein in connection with the processor 212. For example, in one implementation, an Atom™ processor available from Intel Corporation of Santa Clara, Calif., may be used alone or in connection with one or more PIC processors to accomplish various functionality described herein.

Communication interface 224 of locate receiver 120 may be any wired and/or wireless communication interface by which information may be exchanged between locate receiver 120 and an external or remote device, such as a remote computing device that is elsewhere in the dig area (i.e., not a part of the locate receiver 120) or outside the dig area. For example, data that is stored in local memory 220 (e.g., one or more electronic records) may be transmitted via communication interface 224 to a remote computer, such as training computer 110, for processing. Examples of wired communication interfaces may include, but are not limited to, USB ports, RS232 connectors, RJ45 connectors, Ethernet, and any combination thereof. Examples of wireless communication interfaces may include, but are not limited to, an Intranet connection, Internet, Bluetooth® technology, Wi-Fi, Wi-Max, IEEE 802.11 technology (e.g., operating at a minimum bandwidth of 54 Mbps, or any other suitable bandwidth), radio frequency (RF), Infrared Data Association (IrDA) compatible protocols, Local Area Networks (LAN), Wide Area Networks (WAN), Shared Wireless Access Protocol (SWAP), any combination thereof, and other types of wireless networking protocols. The wireless interface may be capable of capturing signals that reflect a user's intent. For example, the wireless interface may include a microphone that can capture a user's intent by capturing the user's audible commands. Alternatively, the wireless interface may interact with a device that monitors a condition of the user, such as eye movement, brain activity, and/or heart rate.

User interface 226 of locate receiver 120 may be any mechanism or combination of mechanisms by which a user may operate locate receiver 120 and by which information that is generated by locate receiver 120 may be presented to the user. For example, user interface 226 may include, but is not limited to, a display device (including integrated displays and external displays, such as Heads-Up Displays (HUDs)), a touch screen, one or more manual pushbuttons, a microphone to provide for audible commands, one or more light-emitting diode (LED) indicators, one or more toggle switches, a keypad, an audio output (e.g., speaker, buzzer, and alarm), and any combination thereof. In one implementation, the user interface 226 includes a “menu/on” button to power up the locate receiver and provide a menu-driven graphical user interface (GUI) displayed by the display device (e.g., menu items and/or icons displayed on the display device) and navigated by the technician via a joystick or a set of four “up/down/left/right” buttons, as well as a “select/ok” button to take some action pursuant to the selection of a menu item/icon. As described below, the display may also be used in some embodiments of the invention to display various images germane to a locate and/or marking information, as well as information relating to a placement of marking material in a dig area, a location of an underground facility in a dig area, or any other suitable information that may be displayed based on information acquired to create an electronic record.

In various embodiments, the one or more interfaces of the locate receiver 120, including the communication interface 224 and user interface 226, may be used as input devices to receive information to be stored in the memory 220, to facilitate various functions of the locate receiver and/or to be logged as part of an electronic record of a locate operation. In some cases, locate information received via the interface(s) (e.g., via the communication interface 224) may include ticket information regarding underground facilities to be detected during a locate operation. As another example, using an interface such as the user interface 226, service-related information may be input, including an identifier for the locate receiver used by the technician, an identifier for a technician, and/or an identifier for the technician's employer. Alternatively, some or all of the service-related information similarly may be received via the communication interface 224. As also noted above, various image information also may be received via the communication interface 224.

The actuation system 214 of locate receiver 120 shown in the block diagram of FIG. 5 may include both electrical and mechanical elements according to various embodiments, and for purposes of illustration is shown in FIG. 5 as included as part of the control electronics 200. The actuation system 214 may include a mechanical and/or electrical actuator mechanism to provide one or more signals or stimuli as an input to the actuation system 214. Upon receiving one or more signals or stimuli (e.g., actuation/triggering by a locate technician or other user), the actuation system 214 may cause the logging of various data constituting locate information. To this end, the actuation system 214 may provide one or more output signals in the form of an actuation signal to the processor 212 to indicate one or more actuations of the locate receiver, in response to which the processor 212 may acquire/collect various locate information and log data into the electronic record.

Location tracking system 230 of locate receiver 120 constitutes another type of input device that provides locate information, and may include any device that can determine its geographical location to a certain degree of accuracy. For example, location tracking system 230 may include a global positioning system (GPS) receiver or a global navigation satellite system (GNSS) receiver. A GPS receiver may provide, for example, any standard format data stream, such as a National Marine Electronics Association (NMEA) data stream, or other data formats. An error correction component may be, but is not limited to, any mechanism for improving the accuracy of the geographic information provided by location tracking system 230; for example, an error correction component may be an algorithm for correcting any offsets (e.g., due to local disturbances in the atmosphere) in the geo-location data of location tracking system 230. An error correction component may reside at the location tracking system 230 or a remote computing device, such as training computer 110. In other embodiments, location tracking system 230 may include any device or mechanism that may determine location by any other means, such as performing triangulation by use of cellular radiotelephone towers.

In one exemplary implementation, the location tracking system 230 may include an ISM300F2-05-V0005 GPS module available from Inventek Systems, LLC of Westford, Mass. (see www.inventeksys.com/html/ism300f2-c5-v0005.html). The Inventek GPS module includes two UARTs (universal asynchronous receiver/transmitter) for communication with the processor 212, supports both the SIRF Binary and NMEA-0183 protocols (depending on firmware selection), and has an information update rate of 5 Hz. A variety of geographic location information may be requested by the processor 212 and provided by the GPS module to the processor 212 including, but not limited to, time (coordinated universal time—UTC), date, latitude, north/south indicator, longitude, east/west indicator, number and identification of satellites used in the position solution, number and identification of GPS satellites in view and their elevation, azimuth and SNR values, and dilution of precision values. Accordingly, it should be appreciated that in some implementations the location tracking system 230 may provide a wide variety of geographic information as well as timing information (e.g., one or more time stamps) to the processor 212.

In other embodiments, location tracking system 230 may not reside locally on locate receiver 120. Instead, location tracking system 230 may reside on any on-site computer, which serves as a location reference point, to which the location of locate receiver 120 may be correlated by any other means, such as, but not limited to, by a triangulation technique between the on-site computer and locate receiver 120.

In further embodiments, locate receiver 120 may include an RF transmitter to transmit an RF signal used for locating the locate receiver. The RF transmitter may be a passive or active device (e.g., a passive or active RFID tag), and may be purely a transmitter or a transceiver (i.e., a combination receiver and transmitter). The RF transmitter may transmit identification information. Two or more detectors (e.g., antennae) may be positioned to receive the RF signal from the RF transmitter. A triangulation component may process the signals received by the two or more detectors to determine a location of the RF transmitter relative to the detectors, and therefore of the locate receiver. The locate receiver, two or more detectors, and triangulation component may therefore form a location tracking system.

With respect to other input devices of the locate receiver 120 that may provide locate information, the control electronics 200 may also include a timing system 228 having an internal clock (not shown), such as a crystal oscillator device, for processor 212. Additionally, timing system 228 may include a mechanism for registering time with a certain degree of accuracy (e.g., accuracy to the minute, second, or millisecond) and may also include a mechanism for registering the calendar date. In various implementations, the timing system 228 may be capable of registering the time and date using its internal clock, or alternatively timing system 228 may receive its time and date information from the location tracking system 230 (e.g., a GPS system) or from an external timing system, such as a remote computer or network, via communication interface 224. In yet other implementations, a dedicated timing system for providing timing information to be logged in an electronic record may be optional, and timing information for logging into an electronic record may be obtained from the location tracking system 230 (e.g., GPS latitude and longitude coordinates with a corresponding time stamp). Timing information may include, but is not limited to, a period of time, timestamp information, date, and/or elapsed time.

Locate receiver 120 may include other instrumentation that may be useful in performing locate operations. In some embodiments, locate device 120 may include, but is not limited to, the following components. Locate receiver 120 may include components for capturing information about environmental conditions, such as, but not limited to, a temperature sensor, a humidity sensor and a light sensor. Locate receiver 120 may further include components for capturing information about the position, orientation and movement of the locate receiver, such as, but not limited to, a compass, an inclinometer, a gyroscope and an accelerometer (in addition to location tracking system 230). In addition, locate receiver 120 may include components for capturing image and/or audio information such as digital cameras, wide angle digital cameras, 360 degree digital cameras, infrared cameras, digital audio recorders, digital video recorders, and the like.

Table 1 shows an example of a sample of locate data that may be captured, for example, at a programmed interval (e.g., such as every 100 milliseconds, every 1 second, etc.) of locate receiver 120 or upon actuation of actuation system 214. It will be understood that the data representative of actual signal parameters will be omitted for embodiments where the detection electronics are not included in locate receiver 120.

A functional block diagram of receiver simulation module 150 in accordance with embodiments of the invention is shown in FIG. 5A. The receiver simulation module 150 may include an optional virtual facilities library 300, a virtual facilities memory 310, a locate simulation memory 320 and a simulation controller 340.

The virtual facilities library 300 may include one or more virtual facilities files. The virtual facilities files include data that simulates actual underground facilities as detected by a locate receiver. The virtual facilities files may correspond to a plurality of virtual sites, one of which may be selected for a training exercise. Different virtual facilities files may have different levels of complexity, different types of facilities and may represent dig sites of different sizes. As indicated above, virtual facilities library 300 is optional in locate receiver 120. When virtual facilities library 300 is omitted, virtual facilities files are downloaded from training computer 110 to virtual facilities memory 310.

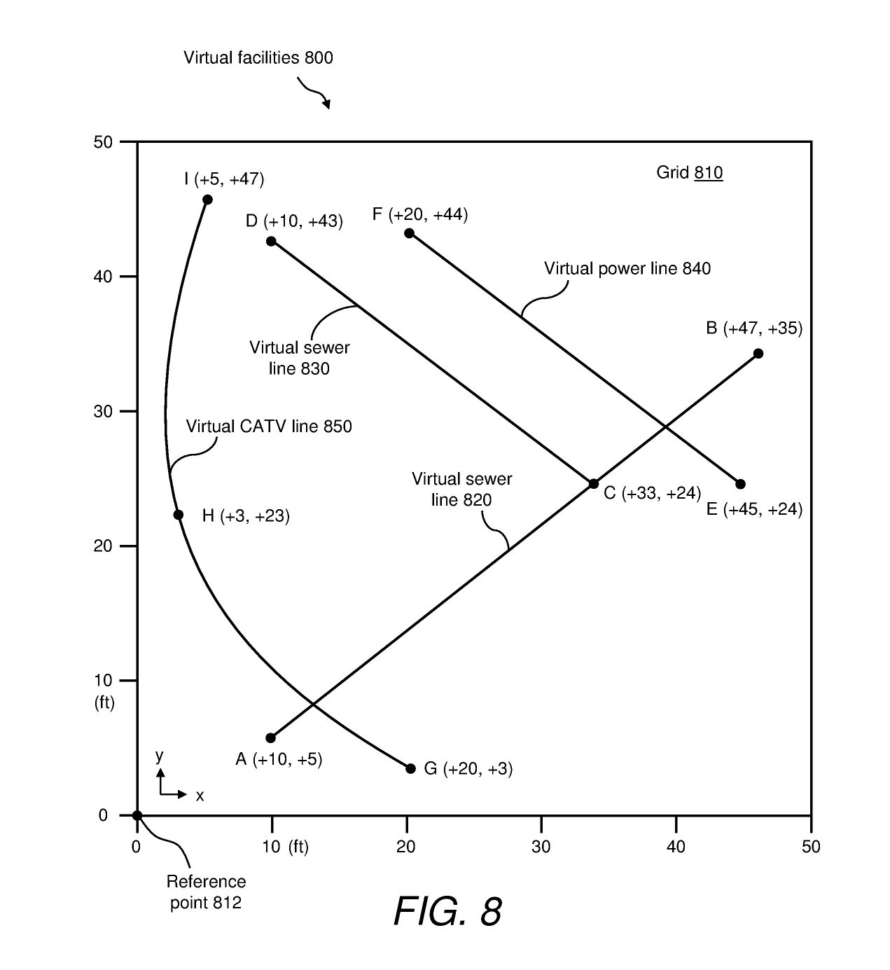

Virtual facilities memory 310 contains a selected virtual facilities file to be used for a current training exercise. An example of an image based on a virtual facilities file is shown in FIG. 8 and described below. As noted above, the selected virtual facilities file may be accessed in virtual facilities library 300 or downloaded from training computer 110.

Simulation controller 340 controls operation of receiver simulation module 150 based on control inputs received from training computer 110. The training computer 110 may download a selected virtual facilities file to virtual facilities memory 310 and instruct simulation controller 340 to begin a training exercise. When the training exercise is initiated, location tracking system 230 (FIG. 5) determines the current geographic coordinates of the locate receiver 120. The current geographic coordinates, after conversion to a suitable format, are used to access virtual facilities memory 310. The format conversion may include a conversion of the current geographic coordinates to the reference coordinates of the virtual facilities data and to a format that is suitable for addressing virtual facilities memory 310. The current geographic coordinates are matched to an entry in virtual facilities memory 310 having geographic coordinates that are closest to the current geographic coordinates of locate receiver 120.

TABLE 1
Example of locate data that may be
captured from locate receiver 120

| | |
|---|---|
| Service provider ID | 0482 |
| Locate technician ID | 4815 |
| Locate Device ID | 7345 |
| Timestamp data | 12-Jul-2008; 09:35:15.2 |
| Geo-location data | N35°43.57518, W078°49.78314 |
| | (deg. and dec. min.) |
| Locate mode | Mode = PASSIVE |
| Gain | 2.0 |
| % Peak Sig. strength | 85% |
| % Null Sig. strength | 7% |
| Signal frequency | 60 Hz |
| Facility depth | 3.4 feet |
| Temperature data | 73 degrees F. |
| Humidity data | 30% |
| Light data | 73% |
| Compass data | 213 degrees |
| Inclinometer data | −40 |
| Accelerometer data | 0.275 |

The virtual facilities data in virtual facilities memory may be organized as a database of geographic coordinates and corresponding simulated signal values. The simulated signal values represent the signal values that would be received by the locate receiver 120 in an actual locate operation. Thus, for example the simulated signal value is greatest at geographic coordinates directly above a virtual facility and is lower or zero for geographic coordinates that are not above the virtual facility. The simulated signal values may include, but are not limited to, percent peak signal strength, percent null signal strength and signal frequency, as shown in Table 1 above.

The simulated signal values output from virtual facilities memory 310 are supplied to user interface 226 (FIG. 5) of locate receiver 120. The user interface indicates to the user the simulated signal value at the current geographic location. The indication may be visual, audible, or a combination thereof. By moving the locate receiver 120 around the area of the virtual facilities, the user obtains from the simulated signal values information regarding the location of the virtual facilities. Based on the simulated signal values, the user performs marking of the virtual facilities with marking device 130 as described below.

In some embodiments, the simulated signal values output from virtual facilities memory 310 may be modified based on the condition of locate receiver 120 and/or by the characteristics of the virtual facilities. For example, the simulated signal values can be modified based on accelerometer outputs, inclinometer outputs, gyroscope outputs and/or gain settings on the locate receiver 120. In addition, the simulated signal values can be modified in accordance with the depth of a virtual facility. The simulated signal values can be modified, for example, by a signal processor that receives the simulated signal values from virtual facilities memory 310 and various inputs which may affect the simulated signal values. The modified signal values are indicated to the user and are stored in locate simulation memory 320.

The user typically swings the locate receiver 120 from side to side in an area expected to have an underground facility. The interpretation by the user of the simulated signal values and the subsequent marking based on that interpretation form a simulated locate operation for evaluation by the training computer 110.

During the training exercise, the data associated with the simulated locate operation, including, for example, the current geographic coordinates, the simulated signal values and timestamps from timing system 228 (FIG. 5) are stored in locate simulation memory 320 to form an electronic record of the simulated locate operation. By storing current geographic coordinates, simulated signal values and timestamps in each entry of the simulated locate record, a chronological record of the simulated locate operation is acquired. The locate simulation data from locate simulation memory 320 can be transmitted to training computer 110 at any time, such as in real time during the training exercise or following completion of the training exercise, and can be processed to evaluate the use of the locate receiver 120.

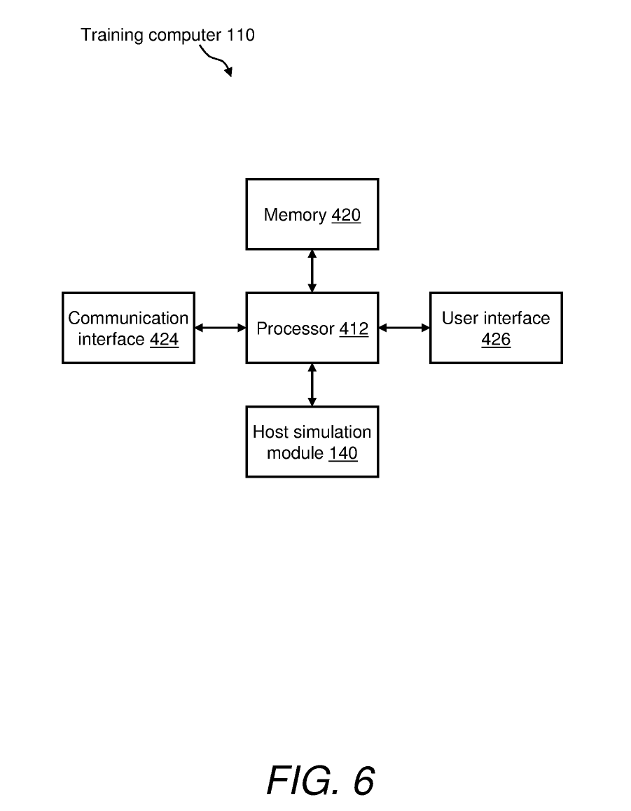

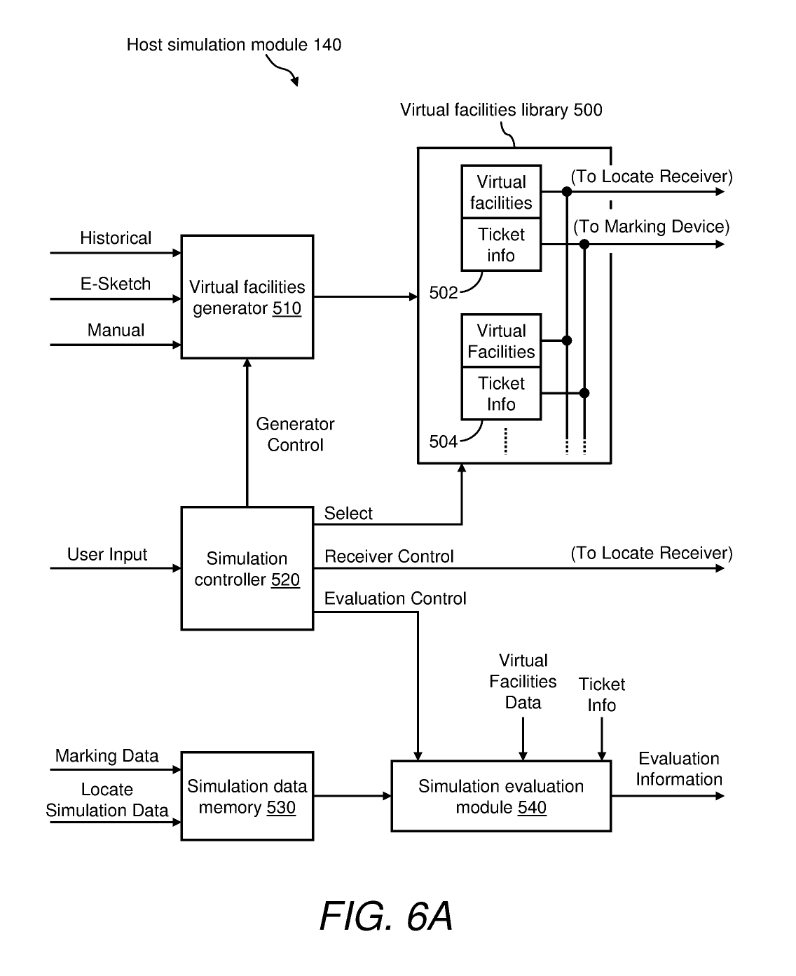

A functional block diagram of training computer 110 is shown in FIG. 6. The training computer 110 may be considered as a training controller which controls a simulated locate operation by the locate receiver, receives and stores locate simulation data and marking data, and processes the data to provide an evaluation of the training exercise. The training computer 110 may be a special purpose controller or a general purpose computer that performs other functions in addition to training. The training computer 110 may be any on-site or remote computer and may perform other functions or may be a dedicated training controller. In some embodiments, training computer 110 may be a laptop computer used by a training instructor. The training computer 110 may be programmed to control one or several training exercises.

As shown in FIG. 6, training computer 110 may include a processor 412, a memory 420, a communication interface 424, a user interface 426 and host simulation module 140. In some embodiments, one or more of the components in FIG. 6 may be the same as, or substantially similar to, components in FIG. 5. For example, in some embodiments, one or more of the following components in FIGS. 6 and 5 may be the same as, or substantially similar to, each other and therefore may function in the same or substantially similar manner: communication interface 224 and communication interface 424; user interface 226 and user interface 426; processor 212 and processor 412; and local memory 220 and local memory 420.

A functional block diagram of host simulation module 140 is shown in FIG. 6A. As shown in FIG. 6A, host simulation module 140, in some embodiments, may include a virtual facilities library 500, a virtual facilities generator 510, a simulation controller 520, a simulation data memory 530 and a simulation evaluation module 540. The memory components of host simulation module 140 may be implemented as areas of memory 420 (FIG. 6) or as separate memory modules.

Virtual facilities library 500 may be organized to store multiple virtual facilities files 502, 504, etc, one of which is selected for a training exercise. Each virtual facilities file may include virtual facilities data and ticket information, for example. The virtual facilities data may include a table of geographic coordinates and corresponding simulated signal values representative of virtual underground facilities. The simulated signal values represent the signals that would be received by a locate receiver at the corresponding geographic coordinates for the given set of virtual facilities. The virtual facilities data may be downloaded to the locate receiver 120 for use during a simulated locate operation. The ticket information corresponds to the virtual facilities data and contains the information that would be provided to a locate technician for the locate operation. The ticket information may be downloaded to the marking device 130. It will be understood that each virtual facilities file may include any desired information and that virtual facilities library 500 may include any number of virtual facilities files.

The virtual facilities library 500 may receive virtual facilities files 502, 504 etc. from virtual facilities generator 510 or from an archive of virtual facilities files stored, for example, at a central location or office. The virtual facilities generator 510 may generate virtual facilities files based on one or more sources of facilities information.

In some embodiments, historical facilities information is used to generate virtual facilities files. The historical information may be based on a actual facilities at a dig site and may be represented by an electronic record acquired by a locate receiver during an actual locate operation. Historical information may be selected based on its value for training purposes. For example, a dig site having a mix of underground facility types and an appropriate complexity level may be selected. In other embodiments, historical information may be obtained from facilities maps and the like.

In some embodiments, virtual facilities information may be obtained from an electronic sketching device. Desired facilities can be drawn on the sketching device. Geographic coordinates and simulated signal values can be determined from the sketched virtual facilities. For example, the simulated signal value can decrease with distance from the sketched virtual facility according to a known function. Electronic sketching devices and methods for underground facility locate operations are described, for example, in U.S. Patent Publication No. 2009/0202112, published Aug. 13, 2009, and entitled “Searchable Electronic Records of Underground Facility Locate Marking Operations,” which is incorporated herein by reference.

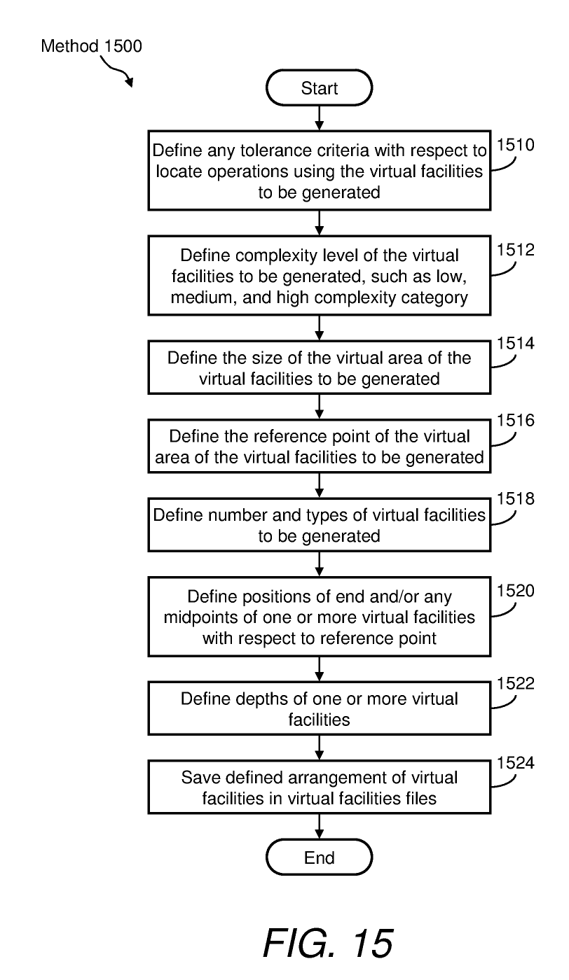

In further embodiments, virtual facilities information can be manually entered into virtual facilities generator 510. An example of manual virtual facilities generation is described below in connection with FIG. 15.

Simulation controller 520 receives user input defining a training exercise to be performed. Assuming that a suitable virtual facilities file is available in virtual facilities library 500, a virtual facilities file is selected by simulation controller 520. The selected virtual facilities data is downloaded to locate receiver 120, and the corresponding ticket information is downloaded to marking device 130. The simulation controller provides control signals to locate receiver 120 to initiate and perform a training exercise using the selected virtual facilities data. Following completion of the simulated locate operation, the simulation controller 520 instructs simulation evaluation module 540 to perform an evaluation of the training exercise. The simulation controller 520 can enable virtual facilities generator 510 to generate virtual facilities files when a simulated locate operation is not being performed

During or after the simulated locate operation by locate receiver 120, locate simulation data may be received and stored in simulation memory 530. During or following the marking operation by marking device 130, the marking data corresponding to the simulation locate operation may be received and stored in simulation data memory 530. In some embodiments, locate simulation data is not utilized, and the training exercise is evaluated based on the marking data alone. The approach is based on an understanding that marking data, representative of marks dispensed on the ground, is the end product of the locate operation.

Simulation evaluation module 540 operates under control of simulation controller 520 and performs an evaluation of the training exercise. As shown in FIG. 6A, simulation evaluation module 540 receives marking data and locate simulation data from simulation data memory 530 and receives virtual facilities data and ticket information from virtual facilities library 500. The virtual facilities data and the ticket information correspond to the selected virtual facilities file. In general, the simulation evaluation module 540 performs an evaluation of the training exercise by comparing the marking data, representative of marks dispensed on the ground, with the virtual facilities data. The difference between the marking data and the virtual facilities data provides a measure of locate technician performance during the training exercise. In some embodiments, the virtual facilities data is used to generate a first image of the virtual facilities, and the marking data is used to generate a second image of the facilities as marked. The two images can be superimposed on a display screen to provide an indication of locate technician performance. In other embodiments, the marking data can be evaluated mathematically by comparison with the virtual facilities data, as described below.

Preferably, marking device 130 is, for example, an electronic, geo-enabled marking device. The marking device may include software components and/or applications, such as, but not limited to, a device health component, a marking data algorithm, a map viewer application, ticket processing software, a speech synthesis component, and an operating mode controller that allows the marking device to operate in multiple modes, such as, but not limited to, marking mode, landmark identification mode, solo mode, and group mode. Additionally, the marking device may include components for capturing information about the marking material; components for capturing information about environmental conditions; components for capturing information about the position, orientation, and movement of the marking device; and components for capturing image and audio information about locate operations. Electronic, geo-enabled marking devices are described, for example, in U.S. patent application Ser. No. 12/703,958, filed Feb. 11, 2010 and entitled “Marking Apparatus Having Enhanced Features for Underground Facility Marking Operations, and Associated Methods and Systems,” which is incorporated herein by reference.

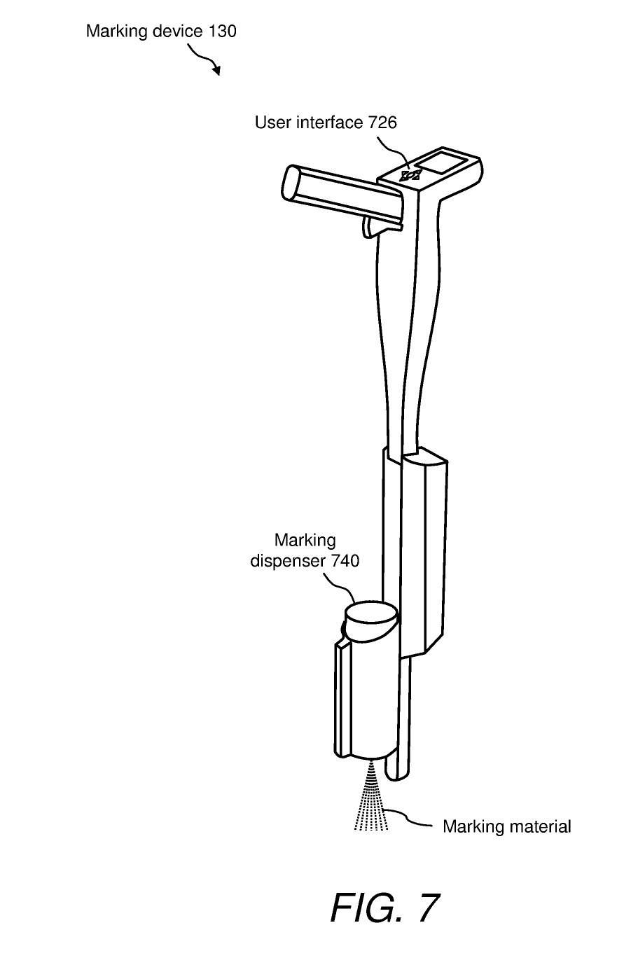

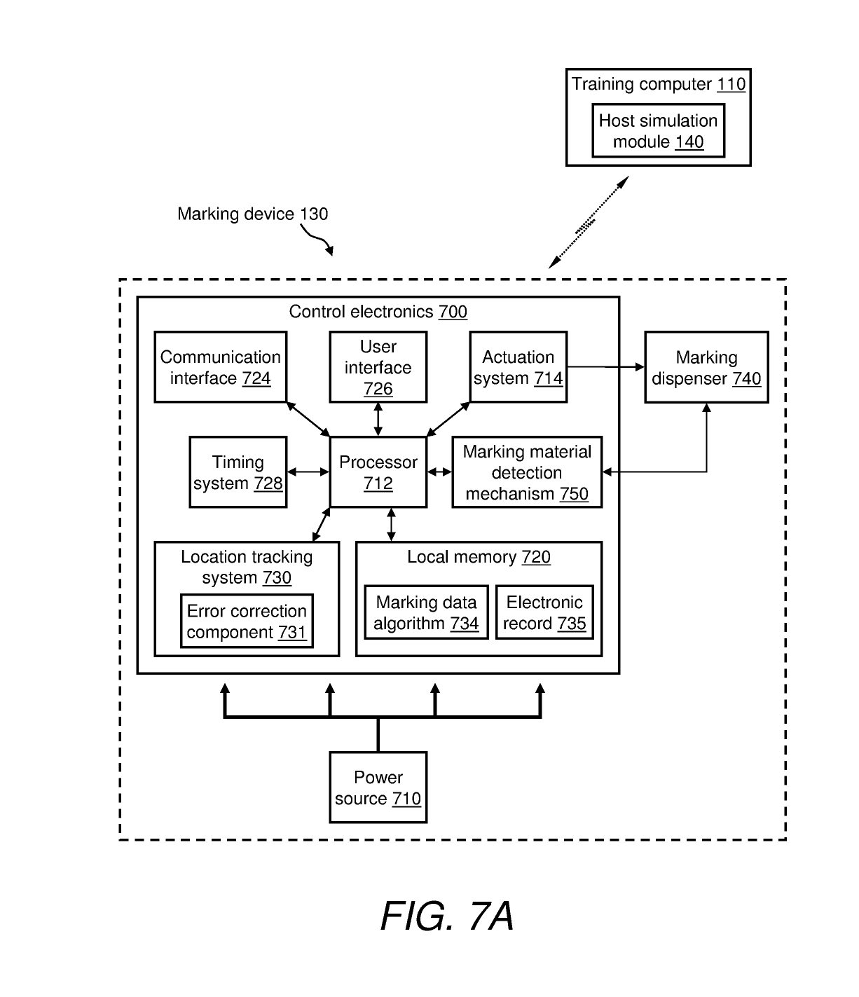

FIG. 7 is a perspective view of marking device 130, and FIG. 7A is a functional block diagram of marking device 130 and training computer 110, according to embodiments of the present invention. Marking device 130 may be configured to sense one or more actuations of the marking device 130 (e.g., to dispense marking material during a marking operation), and to collect information based on one or more actuations of the marking device so as to generate an electronic record.

As shown in FIG. 7A, the marking device 130 includes control electronics 700, a power source 710 configured to power the marking device 130, and a marking dispenser 740. The control electronics 700 includes a processor 712 coupled to a local memory 720, a communication interface 724, a user interface 726, a timing system 728, a location tracking system 730, and an actuation system 714.

Some of the components shown in FIGS. 7 and 7A are similar to components of locate receiver 120 shown in FIG. 5 and described above. According to some embodiments, one or more of the components in FIG. 7A may be the same as, or substantially similar to, components in FIG. 5. For example, in some embodiments, one or more of the following components in FIGS. 7A and 5 may be the same as, or substantially similar to, each other and therefore may function in the same or substantially similar manner: power source 210 and power source 710; communication interface 224 and communication interface 724; user interface 226 and user interface 726; timing system 228 and timing system 728; location tracking system 230 and location tracking system 730; processor 212 and processor 712; local memory 220 and local memory 720; and actuation system 214 and actuation system 714. With respect to actuation system 214, it should be appreciated that no marking material is dispensed by the locate receiver 120 shown in FIG. 5, but the actuation system 214 may nonetheless initiate or control logging of data.

The marking device 130 is configured to hold marking dispenser 740, which as shown in FIG. 7 is loaded into a marking material holder of the marking device 130. In one exemplary implementation, the marking dispenser 740 is an aerosol paint canister that contains paint; however, it should be appreciated that the present invention is not limited in this respect, as a marking material dispensed by the marking device 130 may be any material, substance, compound, and/or element, used to mark, signify, and/or indicate. Examples of marking materials may include, but are not limited to, paint, chalk, dye, and/or marking powder.

The actuation system 714 of marking device 130 shown in the block diagram of FIG. 7A may include both electrical and mechanical elements according to various embodiments, and for purposes of illustration is shown in FIG. 7A as included as part of the control electronics 700. The actuation system 714 may include a mechanical and/or electrical actuator mechanism to provide one or more signals or stimuli as an input to the actuation system 714. Upon receiving one or more signals or stimuli (e.g., actuation/triggering by a locate technician or other user), the actuation system 714 causes marking material to be dispensed from marking dispenser 740. In various embodiments, the actuation system 714 may employ any of a variety of mechanical and/or electrical techniques (e.g., one or more switches or other circuit components, a dedicated processor or the processor 712 executing instructions, one or more mechanical elements, various types of transmitters and receivers, or any combination of the foregoing), as would be readily appreciated by those of skill in the relevant arts, to cause the marking dispenser 740 to dispense marking material in response to one or more signals or stimuli. The actuation system 714 also provides one or more output signals in the form of an actuation signal to the processor 712 to indicate one or more actuations of the marking device, in response to which the processor 712 may acquire/collect various marking information and log data into an electronic record 735.

In some embodiments, the actuation system 714 may be configured so as not to cause marking material to be dispensed from marking dispenser 740 in response to one or more signals or stimuli; rather, the actuation system may merely facilitate a logging of data from one or more input devices in response to operation of an actuator/trigger, without necessarily dispensing marking material. In some instances, this may facilitate “simulation” of a marking operation (i.e., simulating the dispensing of marking material) by providing an actuation signal to the processor 712 indicating one or more simulated actuation events, in response to which the processor may cause the logging of various data for creating an electronic record without any marking material actually being dispensed.

Marking material detection mechanism 750 of the marking device 130 shown in FIG. 7A is another type of input device that provides marking information, and may be any mechanism or mechanisms for determining a presence or absence of a marking dispenser 740 in or otherwise coupled to the marking device 130, as well as determining certain attributes/characteristics of the marking material within marking dispenser 740 when the dispenser is placed in or coupled to the marking device. In some embodiments, the marking material detection mechanism 750 may be disposed generally in an area proximate to a marking material holder in which a marking dispenser 740 may be placed.

In one embodiment, information provided by one or more input devices of the marking device 130 (e.g., the timing system 728, the location tracking system 730, the marking material detection mechanism 750, the user interface 726, the communication interface 724) is acquired and logged (stored in memory) upon actuation of the actuation system 714 (e.g., triggering an actuator). Some embodiments of the invention may additionally or alternatively acquire/log information from one or more input devices at one or more times during or throughout an actuation, such as when a technician is holding a mechanical or electrical actuator for some period of time and moving to dispense marking material in a line. In various aspects of such embodiments, marking information derived from one or more input devices may be collected at a start time of an actuation, at one or more times during an actuation, and in some cases at regular intervals during an actuation (e.g., several times per second, once per second, once every few seconds). Further, some marking information may be collected at an end of an actuation, such as time information that may indicate a duration of an actuation.

Additionally, it should be appreciated that while some marking information may be received via one or more input devices at the start of each marking operation and upon successive actuations of the marking device, in other cases some marking information may be collected by or provided to the marking device once, prior to a marking operation (e.g., on power-up or reset of the marking device, as part of an electronic instruction or dispatch by a locate company, and/or in response to a request/query from a locate technician), and stored in local memory 720 for later incorporation into an electronic record. For example, prior to a given marking operation and one or more actuations of the marking device, ticket information and/or service-related information may have already been received (e.g., via the communication interface 724 and/or user interface 726) and stored in local memory 720. Upon generation of an electronic record of a given marking operation, information previously received via the interface(s) may be retrieved from the local memory (if stored there initially) and entered into an electronic record, in some case together with information collected pursuant to one or more actuations of the marking device. Alternatively, ticket information and/or service-related information may be received via the interface(s) and stored in an entry in the electronic record “directly” in response to one or more actuations of the marking device (e.g., without being first stored in local memory).

In sum, according to embodiments of the present invention, various marking information from one or more input devices, regardless of how or when it is received, may be stored in an electronic record of a marking operation, in which at least some of the marking information is logged pursuant to one or more actuations of the marking device.

Whether resident and/or executed on either the marking device 130 or the training computer 110, a marking data algorithm 734 includes a set of processor-executable instructions (e.g., stored in memory, such as local memory 720 of the marking device) that, when executed by processor 712 of the marking device 130 or another processor, processes information (e.g., various marking information) collected in response to (e.g., during) one or more actuations of the marking device 130, and/or in some cases before or after a given actuation or series of actuations. As also discussed above, according to various embodiments the actuations of marking device 130 may effect both dispensing marking material and logging of marking information, or merely logging of marking information for other purposes (e.g., simulating the dispensing of marking material) without dispensing marking material. In either situation, marking data algorithm 734, when executed by the processor 712, may cause the processor to perform collection, logging/storage (creation of electronic records), and in some instances further processing and analysis of various marking information with respect to marking device actuations.

Table 2 shows an example of a sample of marking data that may be captured as the result of, for example, an actuation of a marking device, such as marking device 130.

In further embodiments, the simulated locate operation may be performed by a combination locate and marking device. The combination locate and marking device combines the functionality of the locate receiver 120 and the marking device 130 in a single device for performing locate operations. A combination locate and marking device is described in U.S. Patent Publication No. 2010/0088032, published Apr. 8, 2010, and entitled “Methods, Apparatus, and Systems for Generating Electronic Records of Locate and Marking Operations, and Combined Locate and Marking Apparatus for Same,” which is incorporated herein by reference.

In further embodiments, processing functions in training system 100 may be performed by one or more cell phones, PDAs (Personal Digital Assistants), smart phones and/or mobile computing devices. For example, the processing functions of locate equipment, including locate receiver 120 and/or marking device 130, may be performed by a cell phone, a PDA, a smart phone and/or a mobile computing device. These components may perform all or part of the processing functions of the respective devices.

TABLE 2
Example of marking data that may be
captured from marking device 130

| | |
|---|---|
| Service provider ID | 0482 |
| Locate technician ID | 4815 |
| Marking Device ID | 7362 |
| Timestamp data | 12-Jul-2008; 09:35:15.2 |
| Geo-location data | N35°43.57518, W078°49.78314 |
| | (deg. and dec. min.) |
| Marking material data | Color = Red, Brand = ABC |
| Temperature data | 73 degrees F. |
| Humidity data | 30% |
| Light data | 73% |
| Compass data | 213 degrees |
| Inclinometer data | −40 |
| Accelerometer data | 0.275 |

FIG. 8 is a top view of virtual facilities 800, which is a graphical representation of the contents of a virtual facilities file 502. A geographic area may be established upon which the virtual facilities are designed. By way of example, FIG. 8 shows an area that is defined by a grid 810. In this example, grid 810 represents an area of 50×50 feet. The 50×50 foot area is exemplary only. Any size area may be defined. A reference point 812 is defined with respect to grid 810 of the virtual facilities 800. For example, reference point 812 may be the 0,0 coordinates of grid 810, or any other designer-defined coordinates. That is, the attributes of virtual facilities 800 may be defined by an offset with respect to the 0,0 coordinates of grid 810.

Virtual facilities 810 may include, for example, a virtual sewer line 820 defined as a substantially straight path between a point A (+10, +5) and a point B (+47, +35); a virtual sewer line 830 defined as a substantially straight path between a point C (+33, +24) and a point D (+10, +43); a virtual power line 840 defined as a substantially straight path between a point E (+45, +24) and a point F (+20, +44); and a virtual CATV line 850 defined as a substantially curved path connecting a point G (+20, +3), a point H (+3, +23), and a point I (+5, +47).

The contents of, for example, virtual facilities 800 may originate entirely or in part from programming. Additionally, contents of virtual facilities 800 may originate entirely or in part from historical marking data, which may be electronic records of marking data of past locate operations.

The virtual facilities are not limited to the example shown in FIG. 8. For example, the virtual facilities may be as simple or complex as desired and may include other virtual features, such as, but not limited to, virtual environmental landmarks, prompts for marking virtual tie downs, and the like. In some embodiments, virtual facilities generated by simulation module 140 may be supplemented by physical elements in an area used for training. For example, “dummy” landmarks, pedestals and/or other components may be placed in the training area. The physical elements provide a frame of reference for the virtual facilities and can be marked using a marking device in the landmark mode, for example.

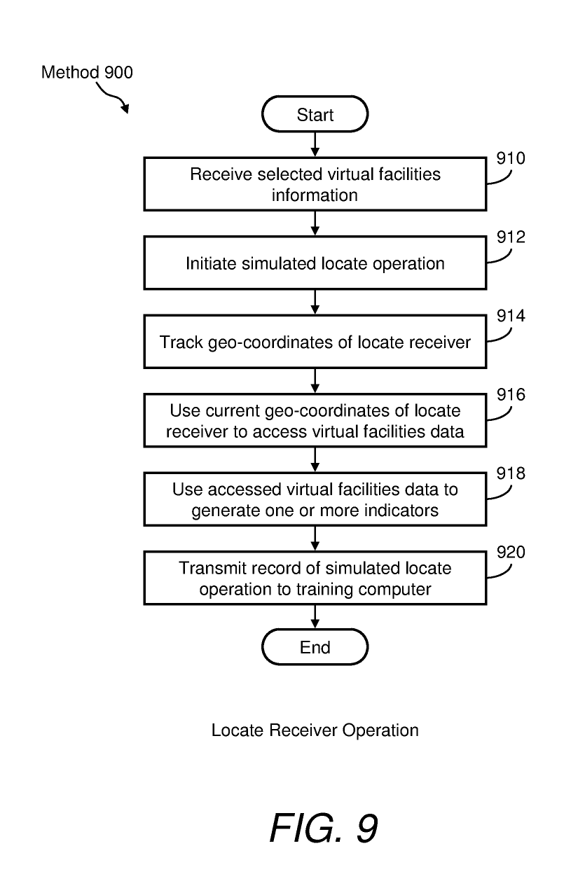

FIG. 9 is a flow diagram of a process 900 performed by locate receiver 120 during a simulated locate operation. It will be understood that the process can include additional acts and that the acts can be performed in a different order from that shown in FIG. 9.

In act 910, the locate receiver 120 receives selected virtual facilities information from training computer 110. The training computer 110 selects a virtual facilities file to be utilized during the simulated locate operation. The virtual facilities data of the virtual facilities file is downloaded from training computer 110 to virtual facilities memory 310 (FIG. 5A) in some embodiments. In other embodiments, the selected virtual facilities data may be stored in virtual facilities library 300 and transferred to virtual facilities memory 310 in response to instructions from training computer 110.

In act 912, training computer 110 instructs locate receiver 120 to initiate a simulated locate operation using the selected virtual facilities data. The user of the locate receiver 120 then moves the locate receiver 120 around the virtual facilities area, typically by swinging the locate receiver 120 from side to side in an area expected to have an underground facility.

In act 914, the location tracking system 230 (FIG. 5) tracks the geographic coordinates of the locate receiver 120 as it is moved around the virtual facilities area.

In act 916, the current geographic coordinates of the locate receiver 120, after suitable format conversion, are used to access the virtual facilities memory 310. In particular, the current geographic coordinates of locate receiver 110 are matched to an entry in virtual facilities memory 310 having geographic coordinates that are closest to the current geographic coordinates of locate receiver 120. The virtual facilities memory 310 outputs a simulated signal value that corresponds to the current geographic coordinates in the virtual facilities data. The simulated signal values are provided to the user interface 226 (FIG. 5) of locate receiver 120 and to locate simulation memory 320.

In act 918, the user interface indicates to the user the simulated signal value at the current geographic location. The indication may be visual, such as a digital or analog value on a display screen, may be audible, such as the frequency or amplitude of a tone, or may include a combination of visual and audible indicators. The simulated signal values inform the user of the locations of the virtual facilities to be marked using marking device 130.

During the simulated locate operation, the data associated with the locate operation, including the current geographic coordinates, the simulated signal values and timestamps from timing system 228 (FIG. 5) are stored in locate simulation memory 320 to form an electronic record of the simulated locate operation. In act 920, the record of the simulated locate operation is transmitted from locate simulation memory 320 to training computer 110. The record may be transmitted at any time, such as in real time during the simulated locate operation or following completion of the simulated locate operation.

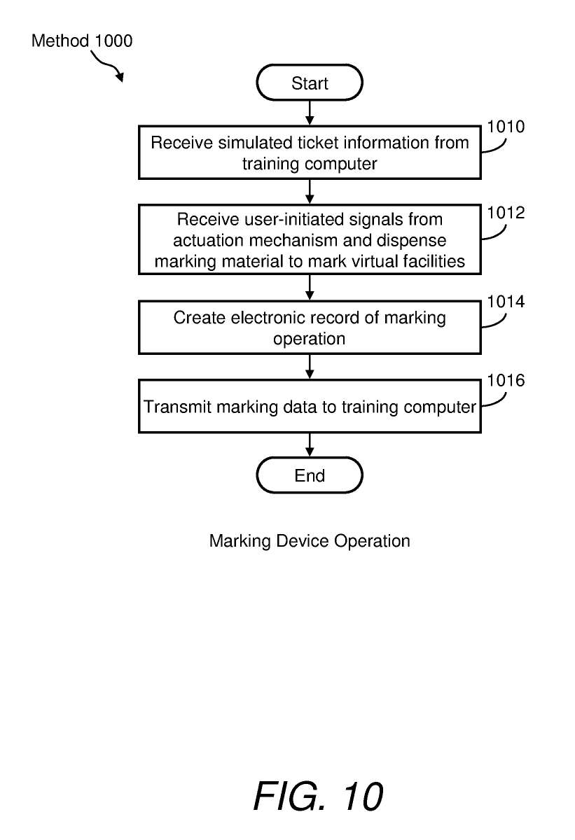

FIG. 10 is a flow diagram of a process 1000 performed by marking device 130 during a simulated locate operation. It will be understood that the process may include additional steps and that the steps can be performed in a different order from that shown in FIG. 10. In some embodiments, the marking device 130 is an electronic, geo-enabled marking device capable of storing and transmitting records of marking operations, but does not include additional hardware or software for performing a simulated locate operation.

In act 1010, the marking device 130 receives simulated ticket information from training computer 110. The simulated ticket information may simulate ticket information sent to the marking device 130 during an actual locate operation. The simulated ticket information for the simulated locate operation corresponds to the virtual facilities represented by the virtual facilities data that has been selected for the simulated locate operation.

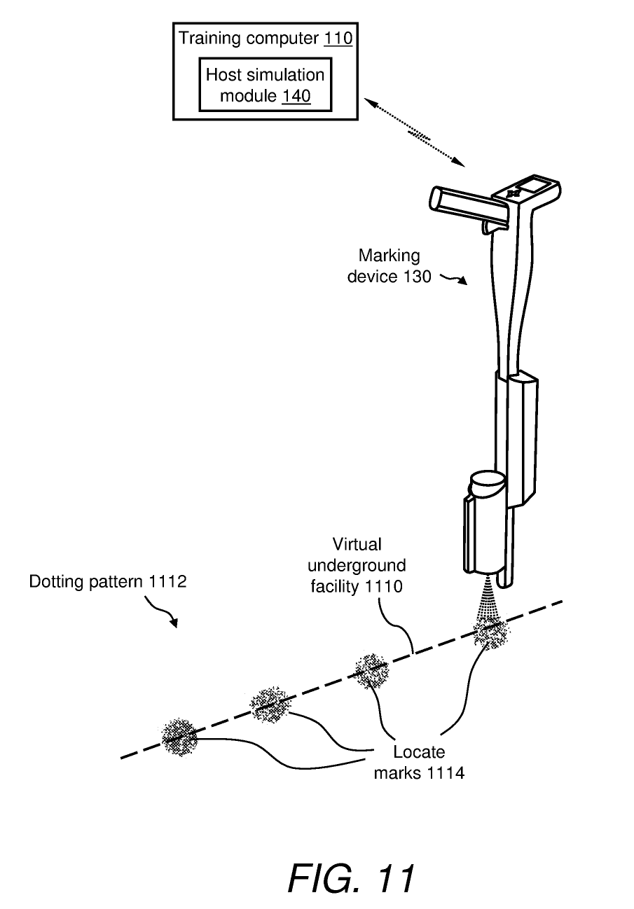

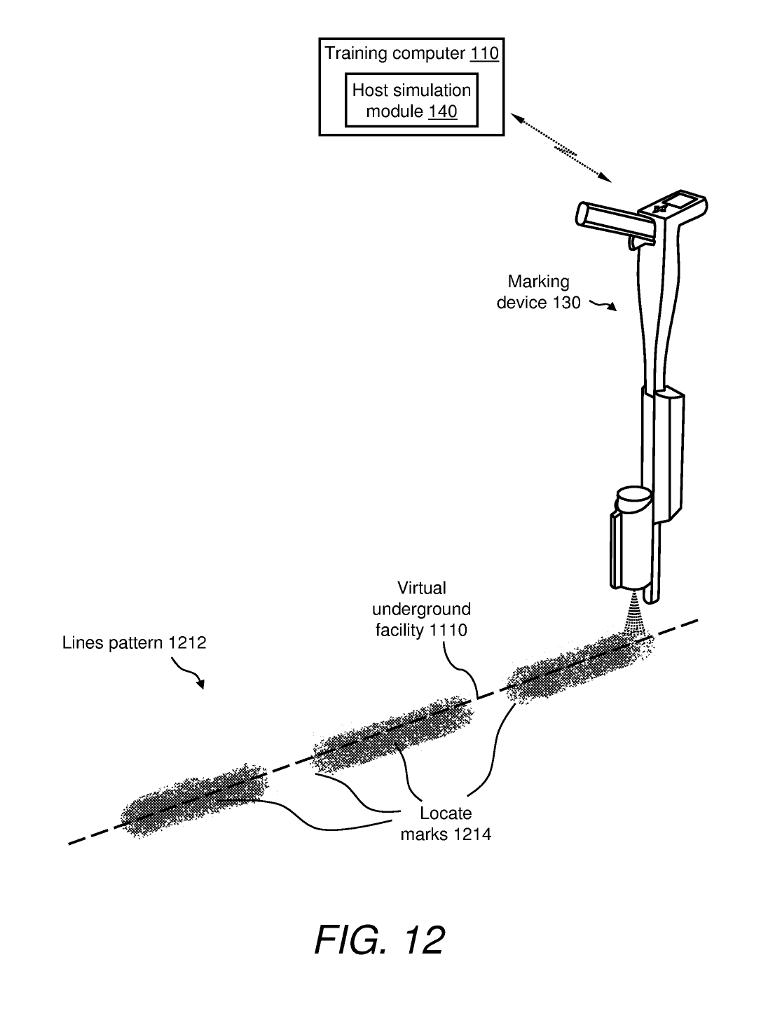

In act 1012, the marking device 130 receives actuations initiated by the user to dispense marking material to mark the virtual facilities. The user actuations of the marking device 130 are based on the user's interpretation of the simulated signal values indicated to the user by the locate receiver 120. A skilled user may dispense marking material accurately at the locations of the virtual facilities, whereas a less skilled user may dispense marking material in a manner that is inaccurate or unacceptable. The parameters to be assessed as part of the simulated locate operation may include the location of the dispensed marking material relative to the virtual facilities, the pattern of the dispensed marking material, the color of the marking material and the completeness of the marking operation. The marking may be performed as described below in connection with FIGS. 11 and 12.

In act 1014, an electronic record of the marking operation is created. In particular, processor 712 (FIG. 7A) may create electronic record 735 in response to actuation signals received from actuation system 714 during dispensing of marking material by marking dispenser 740.

In act 1016, the marking data stored in electronic record 735 may be transmitted to the training computer 110. The marking data may be transmitted to training computer 110 at any time, such as in real time during the marking operation or following completion of the marking operation. Marking device 130 may transmit the marking data to training computer 110 in the same manner that marking data is transmitted to an on-site or remote computer during an actual marking operation.

FIGS. 11 and 12 provide examples of how the marking device 130 shown in FIGS. 7 and 7A may be employed by a locate technician during a marking operation. Referring now to FIG. 11, a perspective view of marking device 130 being used for marking a “dotting pattern” is shown. In marking operations, a dotting pattern may be utilized to preliminarily and quickly indicate the presence or absence of a target facility during an initial locate of a target facility. By way of example, FIG. 11 shows a virtual underground facility 1110, which may be any facility, such as an underground gas line, water pipe, sewer pipe, power line, telephone line, cable television conduit, and the like. FIG. 11 also shows a dotting pattern 1112 that is formed by multiple locate marks 1114 dispensed by marking device 130. The locate marks 1114 of dotting pattern 1112 are formed by successive short bursts of marking material (e.g., brief actuations); i.e., each locate mark 1114 corresponds to one brief actuation of the marking device 130.

Referring now to FIG. 12, a perspective view of marking device 130 being used for marking a “lines pattern” is shown. In marking operations, a lines pattern is typically the end product of a marking operation. This pattern extends the dotting pattern (e.g., dotting pattern 1112 of FIG. 11) so as to create lines (e.g., a series of dashes) that indicate the presence or absence of an underground facility. These lines subsequently provide important reference marks to an excavator so as to avoid damage to a facility during excavation activities or other disturbances of the ground. By way of example, FIG. 12 shows virtual underground facility 1110, which may be any concealed facility, such as an underground gas line, water pipe, sewer pipe, power line, telephone line, cable television conduit, and the like. FIG. 12 also shows a lines pattern 1212 that is formed by multiple locate marks 1214 dispensed by marking device 130. A characteristic of locate marks 1214 of lines pattern 1212 is that each locate mark 1214 is formed by an extended burst of marking material (e.g., a longer actuation of the marking device) as compared with a dotting pattern. As with the dotting pattern shown in FIG. 11, however, each locate mark 1214 of the lines pattern shown in FIG. 12 may correspond to one actuation of marking device 130. In some alternative implementations, a series of locate marks (e.g., all three marks 1214) may be automatically generated by one actuation of marking device 130 pursuant to processor-based control of the actuation system.

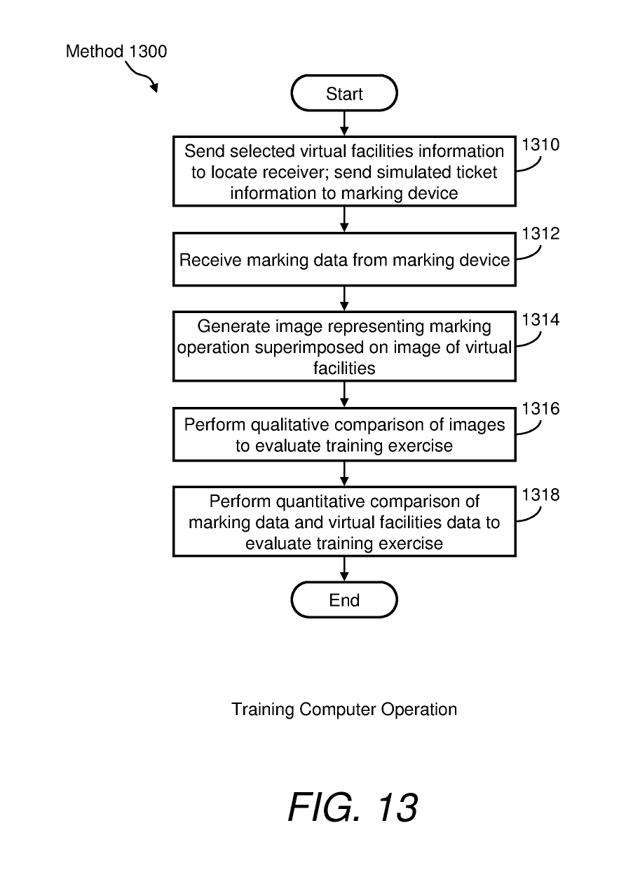

FIG. 13 is a flow diagram of a process 1300 performed by training computer 110 during a simulated locate operation. It will be understood that the process 1300 may include additional acts and that the acts shown in FIG. 13 may be performed in a different order from that shown in FIG. 13.

In act 1310, training computer 110 sends selected virtual facilities information to locate receiver 120 and sends simulated ticket information to marking device 120. As indicated above, the virtual facilities information may include a download of virtual facilities data corresponding to a selected virtual facilities file, or may identify selected virtual facilities data stored in the locate receiver 120. The simulated ticket information corresponds to the selected virtual facilities data and provides information to the user of marking device 130 regarding the selected virtual facilities file. The simulated locate operation is then performed by the user, typically a locate technician, operating the locate receiver 120 and the marking device 130 as described above. A virtual facilities file may be selected based on a complexity level of the training exercise to be performed. For example, the virtual facilities library may include beginner level virtual facilities files, intermediate level virtual facilities files and expert virtual facilities files. Furthermore, the virtual facilities file may be selected based on other criteria, such as the type of facilities, for example. In addition, virtual facilities files may be adjusted to provide specific conditions or features, such as a broken tracer wire and/or facilities with variable depth, for example.

In act 1312, the training computer 110 receives marking data from the marking device. The marking data represents the marking operation performed by the user in response to the simulated signal values provided by the locate receiver 120 as described above. The marking data represents an electronic record of the marking operation performed as part of the simulated locate operation. The training computer 110 may also receive simulated locate data from locate receiver 120. The simulated locate data may provide a record of the simulated locate operation performed by the user with the locate receiver 120.

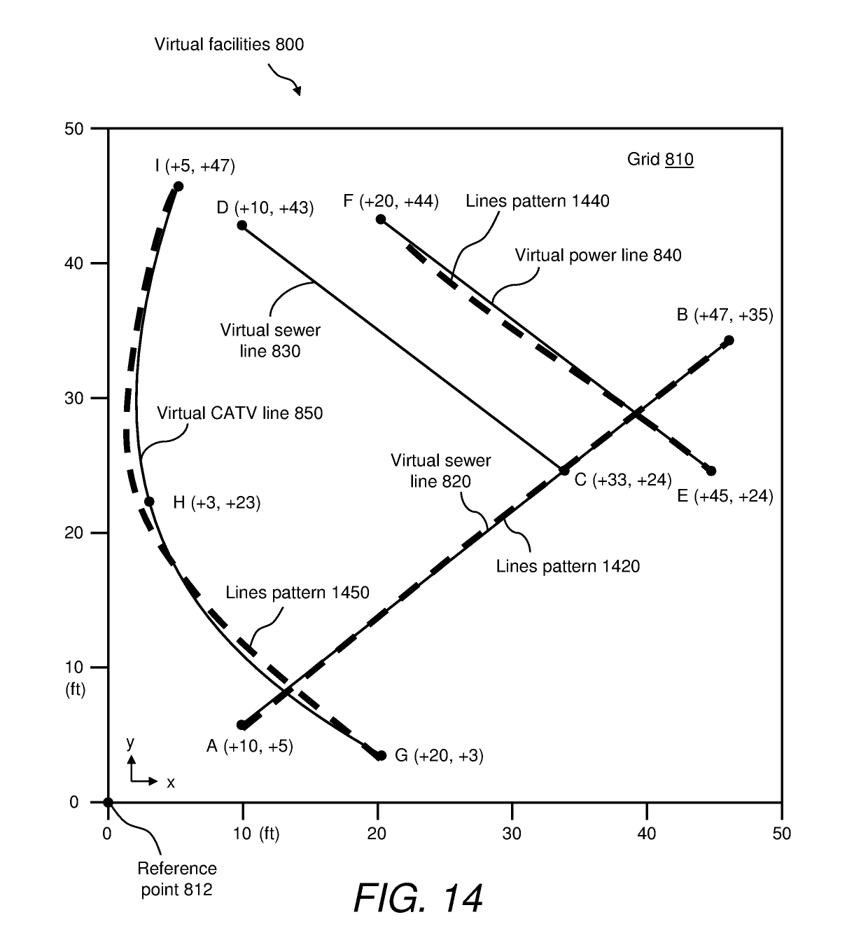

In act 1314, the training computer 110 may generate an image representing the marking operation. The image may be based on the marking data received from the marking device 130 and may be used to evaluate the accuracy, or lack thereof, of the simulated marking operation. The image representing the marking operation may be superimposed on an image of the virtual facilities, as shown in FIG. 14 and described below.

In act 1316, the training computer 110 may enable a qualitative comparison of the image representing the marking data and the image of the virtual facilities to evaluate the training exercise. The evaluation can be based on a comparison of the marking data and the virtual facilities data, as well as determining marking data that is missing or inaccurate.

In act 1318, the training computer 110 can perform a quantitative comparison of the marking data and the virtual facilities data to evaluate the training exercise. For example, the deviation of the marking data from the virtual facilities data can be evaluated by comparing the two data sets. Techniques for comparing data sets are described, for example, in U.S. Pat. No. Publication No. 2010/0088164, published Apr. 8, 2010 and entitled “Methods and Apparatus for Analyzing Locate and Marking Operations with Respect to Facilities Maps,” which is incorporated herein by reference. Evaluation of the training exercise is discussed below.

Techniques for evaluation of the simulated locate operation are described above in connection with acts 1314-1318. It will be understood that other qualitative and quantitative techniques for processing and evaluating the results of the simulated locate operation are included within the scope of the invention. In one example, the marking data may be processed to verify that the locate technician first dispensed a dotting pattern, as shown in FIG. 11, and then dispensed a lines pattern, as shown in FIG. 12. Failure to perform the marking operation in the proper sequence may be a factor in the locate technician's performance evaluation.

FIG. 14 is a top view of an example of marking data electronically overlaid on the display of the corresponding virtual facilities. For example, facilities 800 of FIG. 8 may be the basis of a locate operations training, updating, and/or certification exercise and marking data that is the result of the exercise is analyzed by simulation evaluation module 540 (FIG. 6A). In this example, FIG. 14 shows lines patterns that are electronically overlaid on an electronic representation of virtual facilities 800 of FIG. 8. For example, by analyzing the received marking data from marking device 130, simulation evaluation module 540 renders a lines pattern 1420 that corresponds to virtual sewer line 820, a lines pattern 1440 that corresponds to virtual power line 840, and a lines pattern 1450 that corresponds to virtual CATV line 850. In this example, although expected, a lines pattern that corresponds to virtual sewer line 830 is absent from the received marking data and is, therefore, not rendered. The positions of each mark of lines pattern 1420, lines pattern 1440, and lines pattern 1450 may be rendered according to the position, orientation, and movement information in the received marking data. Further, the color of lines pattern 1420, lines pattern 1440, and lines pattern 1450 may be rendered according to the marking material information in the received marking data.

Further to the example, the received marking data can be compared by simulation evaluation module 540 with the virtual facilities data that represents virtual facilities 800 to determine the degree of matching. The degree of matching may include criteria such as, but not limited to, the following:

whether the number of facilities found in the received marking data matches the number of virtual facilities;

whether the marking material color indicated in the received marking data matches the expected types of virtual facilities;

whether the positions of end points and any midpoints indicated in the received marking data substantially match the positions of the respective end points and any midpoints of the virtual facilities;

whether the positional deviation of markings indicated in received marking data are within a specified tolerance (e.g., about ±18 inches) from center of the virtual facilities;

whether the marking symbols and/or patterns indicated in received marking data are satisfactory with respect to any reference marks; and whether the duration (i.e., total elapsed time) of the simulated locate operation is within an expected range.

With regard to marking material color information included in received marking data, Table 1 shows an example of the correlation of marking material color to the type of facility (or virtual facility) to be marked.

TABLE 3
Correlation of marking material color to facility type

| Marking material | |
|---|---|
| color | Facility Type |
| White | Proposed excavation |
| Pink | Temporary survey markings |
| Red | Electric power lines, cables or conduits, and |
| | lighting cables |
| Yellow | Gas, oil, steam, petroleum, or other hazardous |
| | liquid or gaseous materials |
| Orange | Communications, cable TV, alarm or signal lines, |
| | cables, or conduits |
| Blue | Water, irrigation, and slurry lines |
| Purple | Reclaimed water, irrigation and slurry lines |
| Green | Sewers, storm sewer facilities, or other drain lines |
| Black | Mark-out for errant lines |

By way of example and referring to FIG. 14, which shows the example of the received marking data electronically overlaid on virtual facilities 800 of FIG. 8, the comparison of data may determine the following.
1. The number of facilities found in the received marking data does not match the number of virtual facilities. In particular, lines patterns are present that correspond to virtual sewer line 820, virtual power line 840, and virtual CATV line 850. However, a lines pattern that corresponds to virtual sewer line 830 is absent.
2. The marking material color of lines pattern 1420 that corresponds to virtual sewer line 820 is GREEN and is, therefore, a match according to Table 1.
3. The marking material color of lines pattern 1440 that corresponds to virtual power line 840 is RED and is, therefore, a match according to Table 1.
4. The marking material color of lines pattern 1450 that corresponds to virtual CATV line 850 is BLUE and is, therefore, not a match according to Table 1.
5. The first end point of lines pattern 1420 substantially matches point A of virtual sewer line 820, and the second end point of lines pattern 1420 substantially matches point B of virtual sewer line 820.
6. The first end point of lines pattern 1440 substantially matches point E of virtual power line 840, and the second end point of lines pattern 1440 does not substantially match point F of virtual power line 840.
7. The first end point of lines pattern 1450 substantially matches point G of virtual power line 840, the midpoint of lines pattern 1450 substantially matches point H of virtual power line 840, and the second end point of lines pattern 1450 substantially matches point I of virtual CATV line 850.
8. The positional deviation of markings of lines pattern 1420 is within the accepted tolerance (e.g., about ±18 inches) from center of virtual sewer line 820.
9. The positional deviation of markings of lines pattern 1440 is not within the accepted tolerance (e.g., about ±18 inches) from center of virtual power line 840.
10. The positional deviation of markings of lines pattern 1450 is not within the accepted tolerance (e.g., about ±18 inches) from center of virtual CATV line 850.
11. The lines pattern 1420, lines pattern 1440, and lines pattern 1450 are satisfactory with respect to any reference marks.
12. The location operation duration is 37 minutes, which is in the expected range of 30-60 minutes.

The outcome of the compare operation may be translated into natural language, text, images, and/or any other format by simulation evaluation module 540 to provide evaluation information. In one example, the evaluation information may include the graphical image that is shown in FIG. 14, along with corresponding text and/or audible speech output.

Continuing the example that is shown in FIG. 14, the content of the evaluation may be, for example: “The color of the lines pattern associated with virtual sewer line 820 is correct and the positional accuracy of the marks is satisfactory. The color of the lines pattern associated with virtual power line 840 is correct, however, the positional accuracy of the marks is not satisfactory. The lines pattern associated with virtual sewer line 830 is missing. The color of the lines pattern associated with virtual CATV line 850 is incorrect and the positional accuracy of the marks is not satisfactory. Overall, more training is needed because the locate operation is not satisfactory. In particular, the locate technician should work on improving the accuracy of the marks and needs to pay more attention to detail, such as to selecting the correct marking material color.”

Further, simulation evaluation module 540 may provide a display of, for example, the graphical image shown in FIG. 14, wherein graphical indications (not shown) of the details of the outcome of compare function may be incorporated into the graphical image. For example, the actual points of excessive positional deviation may be indicated, an indication of the wrong marking material color may be indicated, and the like.

Evaluation information may be generated by simulation evaluation module 540 in real time during the simulated locate operations and used, for example, to accomplish immediate corrective action. Additionally, evaluation information may be provided upon completion of the simulated locate operations.

FIG. 15 is a flow diagram of an example of a method 1500 of generating virtual facilities by use of virtual facilities generator 510 (FIG. 6A). Method 1500 may include, but is not limited to, the following acts, which are not limited to any order.

In act 1510, any criteria may be defined with respect to locate operations using the virtual facilities to be generated. In one example, the positional deviation tolerance of markings from the center of the virtual facilities may be set for different skill levels (e.g., low skill level=±24 inches, medium skill level=±18 inches, high skill level=±12 inches). In another example, the expected locate operation duration may be set to a desired value, such as between 30 and 60 minutes.

In act 1512, the complexity level of the virtual facilities to be generated may be defined. For example, the complexity category may be set to low, medium, or high.

In act 1514, the size of the area of the virtual facilities to be generated may be defined. For example, the area of the virtual facilities may be set to 50×50 ft, 75×75 ft, 30×100 ft, and the like.

In act 1516, the reference point of the area of the virtual facilities to be generated may be defined. For example, when the area is represented by a grid, the reference point may be set to the 0,0 coordinates, such as reference point 812 of grid area 810 of FIG. 8.

In act 1516, the number and types of virtual facilities to be generated may be defined. The number and types of virtual facilities defined may be dependent on the complexity level set in act 1512. Using the example of virtual facilities 800 of FIG. 8, four virtual facilities are defined, wherein two virtual facilities are defined as sewer lines (i.e., virtual sewer lines 820 and 830), one virtual facility is defined as a power line (i.e., virtual power line 840), and one virtual facility is defined as a CATV line (i.e., virtual CATV line 850).

In act 1520, the positions of end points and/or any midpoints of one or more virtual facilities with respect to the reference point may be defined. The positions of the virtual facilities may be dependent on the complexity level that is set in act 1512. Again using the example of virtual facilities 800 of FIG. 8, virtual sewer line 820 is defined between point A (+10, +5) and point B (+47, +35); virtual sewer line 830 is defined between point C (+33, +24) and point D (+10, +43); virtual power line 840 is defined between point E (+45, +24) and point F (+20, +44); and virtual CATV line 850 is defined as connecting point G (+20, +3), point H (+3, +23), and point I (+5, +47).

In act 1522, the depths of one or more virtual facilities may be defined. The depths of the virtual facilities may be dependent on the complexity level set in act 1512. Again using the example of virtual facilities 800 of FIG. 8, virtual sewer line 820 may be defined at a depth of 4 feet, virtual sewer line 830 may be defined at a depth of 4 feet, virtual power line 840 may be defined at a depth of 3 feet, and virtual CATV line 850 may be defined at a depth of 3.5 feet.

In act 1524, the defined arrangement of virtual facilities is saved, for example, in virtual facilities files 502, 504, etc. (FIG. 6A). A lookup table may be provided for recording a list of virtual facilities files, which may be queried, for example, by complexity.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present invention.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer may be used to implement system controller 130 in accordance with some embodiments. For example, the computer may include a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for simulating a locate operation to locate the presence or absence of an underground facility in a dig area, comprising:
loading selected virtual facilities data into a virtual facilities memory in locate equipment, the selected virtual facilities data including geographic coordinates in the dig area and corresponding simulated signal values;
sensing current geographic coordinates of the locate equipment with a location tracking device;
accessing simulated signal values in the virtual facilities memory according to the sensed geographic coordinates of the locate equipment; and
indicating the simulated signal values to a user.

2. A method as defined in claim 1, wherein loading selected virtual facilities data includes downloading the selected virtual facilities data from a training controller.

3. A method as defined in claim 1, wherein loading selected virtual facilities data includes loading virtual facilities data from a virtual facilities library in response to a command from a training controller.

4. A method as defined in claim 1, wherein the locate equipment comprises a locate receiver.

5. A method as defined in claim 1, wherein the locate equipment comprises a combination locate and marking device.

6. A method as defined in claim 1, wherein the locate equipment includes a cell phone, a personal digital assistant, a smart phone and/or a mobile computing device.

7. A method as defined in claim 1, further comprising storing in the locate equipment a record of sensed geographic coordinates, corresponding simulated signal values and corresponding timestamps.

8. A method as defined in claim 1, further comprising transmitting a record of sensed geographic coordinates, corresponding simulated signal values and corresponding timestamps to a training controller.

9. A method as defined in claim 1, wherein indicating the simulated signal values includes providing the simulated signal values to a user interface of the locate equipment.

10. A method as defined in claim 1, wherein indicating the simulated signal values includes modifying the simulated signal values based on a condition of the locate equipment and providing the modified signal values to a user interface of the locate equipment.

11. A method as defined in claim 1, wherein the selected virtual facilities data is derived from historical facilities data.

12. A method as defined in claim 1, wherein the selected virtual facilities data is derived from facilities entered on an electronic sketching device.

13. A method as defined in claim 1, wherein the selected virtual facilities data is derived from facilities that were manually entered into a virtual facilities database.

14. A method for controlling a simulated locate operation to locate the presence or absence of an underground facility in a dig area, comprising:
sending information representative of selected virtual facilities data to locate equipment;
receiving marking data representative of a marking operation based on the selected virtual facilities data, the marking data being received from a marking device and including geographic coordinates of the marking device and corresponding marking device actuation data; and
processing the received marking data and the selected virtual facilities data to provide an evaluation of the simulated locate operation.

15. A method as defined in claim 14, wherein the locate equipment comprises a locate receiver.

16. A method as defined in claim 14, wherein the locate equipment comprises a combination locate and marking device.

17. A method as defined in claim 14, wherein the locate equipment includes a cell phone, a personal digital assistant, a smart phone and/or a mobile computing device.

18. A method as defined in claim 14, further comprising selecting a complexity level of the simulated locate operation.

19. A method as defined in claim 14, further comprising adjusting one or more features of the selected virtual facilities data.

20. A method as defined in claim 14, further comprising generating virtual facilities data based on historical facilities data.

21. A method as defined in claim 14, further comprising generating the virtual facilities data based on inputs from an electronic sketching device.

22. A method as defined in claim 14, further comprising generating the virtual facilities data based on manually entered facilities data.

23. A method as defined in claim 14, wherein sending information includes downloading the selected virtual facilities data to the locate equipment.

24. A method as defined in claim 14, wherein sending information includes sending a command to the locate equipment to utilize the selected virtual facilities data from a virtual facilities library.

25. A method as defined in claim 14, wherein processing the received marking data includes generating a first image based on the selected virtual facilities data, generating a second image based on the received marking data and superimposing the first image on the second image to permit evaluation of the received marking data.

26. A method as defined in claim 14, wherein processing the received marking data includes comparing the received marking data with the selected virtual facilities data and using the results of the comparison to provide an evaluation of the simulated locate operation.

27. A method as defined in claim 14, wherein the locate equipment includes a locate receiver, further comprising sending simulated ticket information to a marking device associated with the locate receiver.

28. A method as defined in claim 14, wherein processing the received marking data includes comparing the received marking data with the selected virtual facilities data and providing a score that indicates a level of performance of the user.

29. A method as defined in claim 14, wherein processing the received marking data includes comparing the received marking data with the selected virtual facilities data and providing an evaluation of the simulated locate operation which is consistent from user-to-user.

30. A method as defined in claim 14, wherein processing the received marking data includes comparing the received marking data with the selected virtual facilities data and deciding whether to certify the user based on the results of the comparison.

31. A method as defined in claim 14, wherein processing the received marking data includes automatically generating an evaluation of the simulated locate operation.

32. A locate receiver for simulating a locate operation to locate the presence or absence of an underground facility in a dig area, comprising:
a location tracking device to sense current geographic coordinates of the locate receiver;
a virtual facilities memory to store selected virtual facilities data, the selected virtual facilities data including geographic coordinates and corresponding simulated signal values;
a memory access module to access simulated signal values in the virtual facilities memory according to the sensed geographic coordinates of the locate receiver; and
a user interface to indicate the accessed signal values to a user.

33. A training controller to control a simulated locate operation to locate the presence or absence of an underground facility in a dig area, comprising:
a control module to send information representative of selected virtual facilities data to a locate receiver;
a simulation data memory module to receive and store marking data representative of a marking operation based on the selected virtual facilities data; and
a simulation evaluation module to process the received marking data and the selected virtual facilities data to provide an evaluation of the simulated locate operation.

34. A training system for simulating a locate operation to locate the presence or absence of an underground facility in a dig area, comprising:
a training controller configured to send information representative of selected virtual facilities data to a locate receiver, to receive marking data representative of a marking operation based on the selected virtual facilities data and to process the received marking data and the selected virtual facilities data to provide an evaluation of the simulated locate operation;
a locate receiver configured to load the selected virtual facilities data into a virtual facilities memory, the virtual facilities data including geographic coordinates and corresponding simulated signal values, to sense current geographic coordinates of the locate receiver with a location tracking device, to access signal values in the virtual facilities memory according to the sensed geographic coordinates of the locate receiver, and to indicate the accessed signal values to a user; and
a marking device configured to receive marking device actuations from a user based on the accessed signal values indicated to the user and to send marking data to the training controller, the marking data including geographic coordinates of the marking device and the corresponding marking device actuation data.

35. A method for training a locate technician to perform a locate operation to locate the presence or absence of an underground facility in a dig area, comprising:
selecting, in a training controller, virtual facilities data for training;
sending the selected virtual facilities data from the training controller to locate equipment;
loading the selected virtual facilities data into a virtual facilities memory in the locate equipment;
sensing current geographic coordinates of the locate equipment with a location tracking device;
accessing signal values in the virtual facilities memory according to the sensed geographic coordinates of the locate equipment;
indicating the accessed signal values to the locate technician;
receiving, by a marking device, actuations by the locate technician based on the indicated signal values;
generating, by the marking device, marking data based on the received actuations;
sending the marking data from the marking device to the training controller; and
processing, by the training controller, the marking data and the selected virtual facilities data to provide an evaluation of the simulated locate operation.

36. A method for generating a virtual facilities file containing virtual facilities representative of underground facilities in a dig area, comprising:
defining tolerances with respect to locate operations using the virtual facilities;
defining a complexity level of the virtual facilities;
defining a size of a virtual area containing the virtual facilities;
defining a reference point of the virtual area of the virtual facilities;
defining the number and types of virtual facilities;
defining positions of the virtual facilities with respect to the reference point;
defining the depths of the virtual facilities; and
saving the defined virtual facilities in a virtual facilities file for use during a simulated locate operation.
